(19) United States
(12) Patent Application Publication
(10) Pub. No.: US 2023/0364860 A1
(43) Pub. Date: Nov. 16, 2023

(54) METATHESIS POLYMERIZATION BINDERS FOR ADDITIVE MANUFACTURING

(71) Applicant: Desktop Metal, Inc., Burlington, MA (US)

(72) Inventors: Brian Creran, Burlington, MA (US); Robert J. Nick, Pepperell, MA (US); Alexander C. Barbati, Melrose, MA (US); Benjamin Robert Lund, Mabank, TX (US)

(73) Assignee: Desktop Metal, Inc., Burlington, MA (US)

(21) Appl. No.: 18/315,021

(22) Filed: May 10, 2023

Related U.S. Application Data
(60) Provisional application No. 63/340,859, filed on May 11, 2022.

(51) Int. Cl. B29C 64/165; B22F 10/14; B33Y 10/00; B33Y 70/00

(52) U.S. Cl. CPC B29C 64/165; B22F 10/14; B33Y 10/00; B33Y 70/00; B29K 2105/0002

(57) ABSTRACT

Techniques are provided for fabricating parts via additive manufacturing by causing a component of a build material powder to contact a binder composition to thereby perform a metathesis chain-growth polymerization reaction (e.g., an olefin metathesis polymerization reaction such as ring-opening metathesis polymerization).

### CROSS-REFERENCE TO RELATED APPLICATIONS

The present application claims the benefit under 35 U.S.C. § 119(e) of U.S. Provisional Patent Application No. 63/340,859, filed May 11, 2022, titled “Ring Opening Metathesis Polymerization Binders for Additive Manufacturing,” which is hereby incorporated by reference in its entirety.

### TECHNICAL FIELD

Methods of additive manufacturing, binder compositions for additive manufacturing, and articles produced by and/or associated with methods of additive manufacturing are generally described.

### BACKGROUND

Additive fabrication, e.g., 3-dimensional (3D) printing, provides techniques for fabricating objects, typically by causing portions of a building material to solidify at specific locations. Additive fabrication techniques may include techniques categorized as vat photopolymerization, powder bed fusion, binder jetting, material jetting, sheet lamination, material extrusion, directed energy deposition, or combinations thereof. Many additive fabrication techniques build parts by forming successive layers, which are typically cross-sections of the desired object. Typically each layer is formed such that it adheres to either a previously formed layer or a substrate upon which the part is built.

One additive fabrication technology suitable for fabricating parts from finely-divided (e.g., powdered) build materials is Binder Jetting, in which parts are fabricated through the application of a binder to a build material powder. The binder allows the part geometry to be built up, or formed by selective joining, without locally melting the metal by effectively “gluing” portions of metal powder together. Subsequently, the resulting “green part” or “brown part” is processed for debinding and sintering in a furnace to produce a fully dense metal part.

### SUMMARY

According to some aspects, a method of additive manufacturing is provided comprising forming one or more parts by performing, a plurality of times, depositing a layer of build material powder, wherein particles of the build material powder are coated with a catalyst, and depositing a binder composition on at least a portion of the layer of build material powder, the binder composition comprising a precursor material comprising a monomer and/or a polymer, the monomer and/or polymer comprising an unsaturated carbon-carbon bond, thereby causing the monomer and/or polymer of the precursor material to undergo a metathesis chain-growth polymerization reaction catalyzed by the catalyst.

According to some aspects, a method of additive manufacturing is provided comprising forming one or more parts by performing, a plurality of times, depositing a layer of build material powder, wherein particles of the build material powder are coated with a precursor material comprising a monomer and/or a polymer, the monomer and/or polymer comprising an unsaturated carbon-carbon bond, and depositing a binder composition on at least a portion of the layer of build material powder, the binder composition comprising a catalyst, thereby causing the monomer and/or polymer of the precursor material to undergo a metathesis chain-growth polymerization reaction catalyzed by the catalyst.

According to some aspects, a method of additive manufacturing is provided comprising forming one or more parts by performing, a plurality of times, depositing a layer of build material powder, wherein particles of the build material powder are coated with a latent catalyst and a precursor material comprising a monomer and/or a polymer, the monomer and/or polymer comprising an unsaturated carbon-carbon bond, and depositing a binder composition on at least a portion of the layer of build material powder, the binder composition comprising an activator, thereby causing the monomer and/or polymer of the precursor material to undergo a metathesis chain-growth polymerization reaction catalyzed by the catalyst upon activation by the activator.

According to some aspects, a method of additive manufacturing is provided comprising forming one or more parts by performing, a plurality of times, depositing a layer of build material powder, wherein particles of the build material powder are coated with an activator, and depositing a binder composition on at least a portion of the layer of build material powder, the binder composition comprising a latent catalyst and a precursor material comprising a monomer and/or a polymer, the monomer and/or polymer comprising an unsaturated carbon-carbon bond, thereby causing the monomer and/or polymer of the precursor material to undergo a metathesis chain-growth polymerization reaction catalyzed by the catalyst upon activation by the activator.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIGS. 1A-1B show non-limiting diagrams of methods of additive manufacturing, in accordance with some embodiments;

FIG. 2 shows a non-limiting embodiment of a method of depositing a layer of build material powder, in accordance with some embodiments;

FIG. 3A shows a non-limiting embodiment of a method of depositing a binder composition onto at least a portion of a layer of build material powder, in accordance with some embodiments;

FIG. 3B shows a non-limiting embodiment of a method step of depositing a second powder layer on a first powder layer onto which a binder composition had been deposited, in accordance with some embodiments;

FIG. 3C shows a non-limiting embodiment of a layer onto which a binder composition has been deposited, in accordance with some embodiments;

FIG. 4 shows one non-limiting embodiment of a method of drying and/or cross-linking a binder composition, in accordance with some embodiments;

FIG. 5 shows one non-limiting embodiment of a method of heating a build material-based composite structure, in accordance with some embodiments;

FIG. 6 shows one non-limiting embodiment of a method of heating a de-bound build material structure, in accordance with some embodiments;

FIGS. 7A-7B show two similar versions of an exemplary additive manufacturing system, in accordance with some embodiments;

FIG. 8 shows one non-limiting embodiment of an additive manufacturing plant, in accordance with some embodiments;

FIG. 9 shows an image of bars created out of 17-4 stainless steel powder (left) and aluminum powder (right), where the shiny layer on one of the 17-4 bars is excess polymer and was removed before mechanical testing, according to some embodiments;

FIG. 10 shows an image of (left) a droplet ejected onto an aluminum powder bed and (right) the powder bed after one second after droplet ejected, according to some embodiments; and

FIG. 11 shows an image of the resultant aluminum/resin composite after hardening, according to some embodiments.

### DETAILED DESCRIPTION

As described above, some conventional additive fabrication techniques may apply energy to a build material powder (e.g., metal powder) to melt the powder and thereby create solid regions of build material (e.g., metal). Such techniques may, however, present safety concerns due to the explosive potential of some build material powders. As a result, such techniques are generally employed in inert environments requiring a great deal of associated infrastructure. Moreover, the energy required to melt many materials such as metals is comparatively high, leading to a slow and expensive fabrication process.

Another additive fabrication technology suitable for fabricating parts is Binder Jetting, in which build material parts are fabricated through the application of an organic binder to a bed of build material powder. The binder contains an organic component in a solvent, and the solvent is subsequently removed through vaporization. The organic binder component that remains allows the part geometry to be built up without locally melting the build material by effectively “gluing” particles of build material powder together. Subsequently, the resulting ‘green’ part is cured to increase the strength of the part (e.g., through cross-linking or steric binding or hinderance of the organic binder component), and is then sintered in a furnace to produce a fully dense build material part.

The inventors have recognized and appreciated techniques for fabricating sinterable parts by causing a component of a build material powder to contact a binder composition to thereby perform a metathesis chain-growth polymerization reaction (e.g., an olefin metathesis polymerization reaction such as ring-opening metathesis polymerization). For example, the techniques may comprise coating a build material powder (e.g., a metal or ceramic powder) with a precursor material comprising a monomer and/or polymer, and depositing a binder composition that contains a catalyst onto the coated build material powder, thereby causing the monomer and/or polymer to undergo a metathesis chain-growth polymerization reaction. As another example, the techniques may comprise coating a build material powder with a catalyst (e.g., an alkylidene-containing metal-centered catalyst), and depositing a binder composition that contains a precursor material comprising a monomer and/or polymer onto the build material powder, thereby causing the monomer and/or polymer to undergo a metathesis chain-growth polymerization reaction. Embodiments involving latent catalysts and activators (e.g., bases) are also described. The precursor material and/or catalyst may be selected to produce a desired polymer. The binder composition may, in at least some embodiments, be deposited using conventional binder jetting techniques.

The described techniques may have an advantage over conventional binder compositions that contain polymers rather than polymer precursors, which limit their loadings in the binder fluid to viscosities that can be jetted by the inkjet printhead. Also, the poor solubility of some polymers in inkjet-friendly solvents may have limited use as a general inkjet binder material in additive fabrication. In contrast, the techniques described herein may allow for the use of a particular polymer as a binder that could not otherwise be successfully used as a binder.

As noted above, some instances of metathesis chain-growth polymerization reactions involve ring-opening metathesis polymerization. According to some embodiments, a binder may utilize the so-called ring opening metathesis polymerization (ROMP) reaction to create strong parts out of a wide range of metals or other powders. In brief, the ROMP reaction occurs when certain olefin monomer material, for example including materials containing a ring with two double bonds, interacts with a metal (e.g., transition metal) catalyst causing the monomer material to open which propagates the reaction, in the case of a monomer material containing a ring. This technique may require no other outside intervention, and may cause a comparatively low viscosity monomer fluid to become a hardened polymer block within several minutes. This reaction is quite attractive for binder development, as the catalyst can be incorporated into a metal or other powder of interest, requiring just the monomer itself to be jetted onto the powder to cause the toughening reaction to start. Once completed, no further crosslinking step may be needed, since the parts so fabricated should be sufficiently stable for depowdering. Debinding of the parts may be straightforward, since the resulting polymer burns off nearly completely during sintering as it is predominately a saturated alkane polymer chain containing no oxygen or nitrogen impurities. As polymerization is not impacted by the powder mix, composites of any material could be made provided it can be wetted out in the resin material.

The inventors have recognized and appreciated that the above-described technology may have several advantages. Since the polymerization process may be agnostic to the material of interest, the approach may be utilized to fabricate parts from a wide range of metals or other materials such as 17-4 stainless steel, aluminum, marble (calcium carbonate), zirconium, titanium, blended carbon & polyethylene powder as well as wood resin, wood, ceramics, recycled plastics, ceramic microspheres, and sand without the need for a crosslinking step before depowdering. Lot-to-lot variances between powders may also be minimized as the ROMP reaction is seemingly unaffected by the type of primary powder material. Desired wetting properties between the binder composition and powder may be achieved using a binder composition that contains 100% monomers, or by diluting the monomer with a solvent. Depowdering efficiency will be improved and automating this step could be possible as the parts created are quite rigid even before heating. Strength may be improved and/or flexibility added by the addition of monomers to the binder composition, such as cyclooctene.

It is believed that current binder jetting systems and/or configurations are incompatible with metathesis chain-growth polymerization (e.g., ROMP) materials (e.g., the monomer/polymer to be polymerizes and/or the catalyst). For example, it is believed that current commercial systems do not use multi-component (e.g., two-component) approaches where a build material powder is coated with a first component and a second component is deposited (e.g., jetted) onto the build material powder to cause a reaction tending to provide strength to the resulting three-dimensional compositions and/or build material-based composite structures. For example, many current systems use aqueous solutions or at least contain some water (e.g., mixtures of glycerol and water, alcohol and water,), which may be reactive with at least some metathesis chain-growth polymerization (e.g., ROMP) reagents. While some current systems do use non-aqueous solvents for reactive metals, the reason is because water-based solvents may cause a gas-generating reaction, for example, and not because non-aqueous solvents would have been understood to be useful for a polymerization reaction compatibility. It also believed that depositing (e.g., jetting) the precursor material (e.g., monomer) would be understood to be non-trivial without the benefit of this disclosure at least for reasons of chemical compatibility and/or an ability to attain the desired performance characteristics of a deposited drop (e.g., volume, lack of satellites). It is also believed that debinding following a metathesis chain-growth polymerization reaction would be understood as being non-trivial without the benefit of this disclosure. For example, in a debinding process, it may be desired that the binder be removed without leaving behind carbonaceous or other residue. The amount of residue left behind can depend, generally, upon (1) the temperature profile applied during the debinding process, (2) the gaseous species (if any) present during the debinding process, (3) the pressure (including partial pressure) of the gaseous species present during the debinding process, (4) the nature of the solids pervaded by the binder to be removed, (5) the relative spatial orientation and topology of the build material powder and the binder to be removed, and (6) the chemical nature of the binder material, including, at least (a) the chemistry of the monomer and/or polymer to be polymerized, and (b) the topology of the polymer chains (e.g., linear, dendritic, linked chains) among other attributes.

Some embodiments for forming a part involves depositing a layer of build material powder, wherein particles of the build material powder are coated with a precursor material. The precursor material may comprise a monomer and/or a polymer comprising an unsaturated carbon-carbon bond (e.g., a carbon-carbon double bond). The monomer may be, for example, a cyclic or bicyclic olefin such as dicyclopentadiene. A binder composition comprising a catalyst may be deposited (e.g., via binder jetting) on at least a portion of the deposited build material powder. The catalyst may be, for example, an alkylidene-containing metal-centered catalyst such as a ruthenium alkylidene complex. The arrangement of the precursor material and the catalyst may also be switched, such that the methods involve depositing a layer of build material powder, wherein particles of the build material powder are coated with the catalyst. Then, a binder composition comprising the precursor material may be deposited (e.g., via binder jetting) on at least a portion of the deposited build material powder.

The build material powder may be coated with the precursor material and/or the catalyst (and/or the activator) via any of a variety of techniques. For example, the powder may be contacted with a solution containing the material to be coated onto the powder and then at least a portion (or all) of the liquid from the solution may be removed. As one example, the coating material (e.g., the catalyst or the precursor material) may be dissolved in a solvent, and then the build material powder may be added to the resulting solution to create a slurry or suspension. Subsequently, the solvent may be removed (e.g., via evaporation), thereby producing coated build material powder. Materials coated on the build material may be present as in any of a variety of manners. For example, coated material may be present as domains (e.g., continuous layers, particles) of material having a largest dimension (e.g., layer thickness, particle diameter, etc.) of less than or equal to 10 microns, less than or equal to 1 micron, less than or equal to 100 nm, less than or equal to 10 nm, and/or as low as 1 nm, or less. These dimensions can be determined by, for example, scanning electron microscopy and/or transmission electron microscopy. In some embodiments, a ratio of the largest average cross-sectional dimension of the particles of the build material to largest dimension of the largest dimension of the domains of the coated material (e.g., layer thickness, particle diameter, etc.) is greater than or equal to 3, greater than or equal to 5, greater than or equal to 10, greater than or equal to 20, greater than or equal to 50, greater than or equal to 100, and/or up to 200, up to 500, up to 1000, up to 10000, or greater. Combinations of these ranges are possible.

The exposure of the precursor material to the catalyst may cause the monomer and/or polymer to undergo a metathesis chain-growth polymerization reaction (e.g., an olefin metathesis polymerization such as ROMP) catalyzed by the catalyst. In some such instances, no further stimulation (e.g., via heating, irradiation, etc.) is needed for the metathesis chain-growth polymerization to occur. Accordingly, a curing step may not be necessary (although in some instances curing (e.g., via heating) may be performed to cause and/or accelerate the polymerization.

While in some embodiments the precursor material comprising the monomer and/or polymer and the catalyst are separated until the binder composition is deposited, in other embodiments both the precursor material and the catalyst are provided together (e.g., in the coating on the build material powder and/or in the binder composition). In some such embodiments, the catalyst is a latent catalyst requiring exposure to an activator (e.g., a base) to begin catalyzing the polymerization reaction. The activator may be separated from the catalyst until the binder composition is deposited. For example, the catalyst may be in the coating on the build material powder and the activator may be in the binder composition, or the opposite arrangement may be used where the catalyst is in the binder composition and the activator coats at least a portion of the build material powder.

It should be understood that some binder compositions and/or coatings described herein may have all of the above-described advantages, some binder compositions and/or coatings described herein may have a subset of the above-described advantages, and binder compositions and/or coatings described herein may have none of the above-described advantages. Similarly, some binder compositions and/or coatings described herein may have advantages not described above and/or may be desirable for use in a variety of applications for reasons not described above. Particular features of binder compositions and/or coatings that may promote one or more of the above-described advantages are described in further detail below.

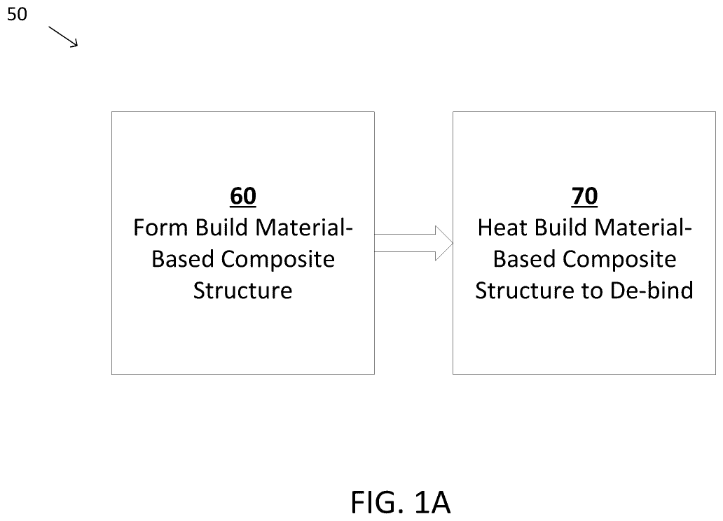

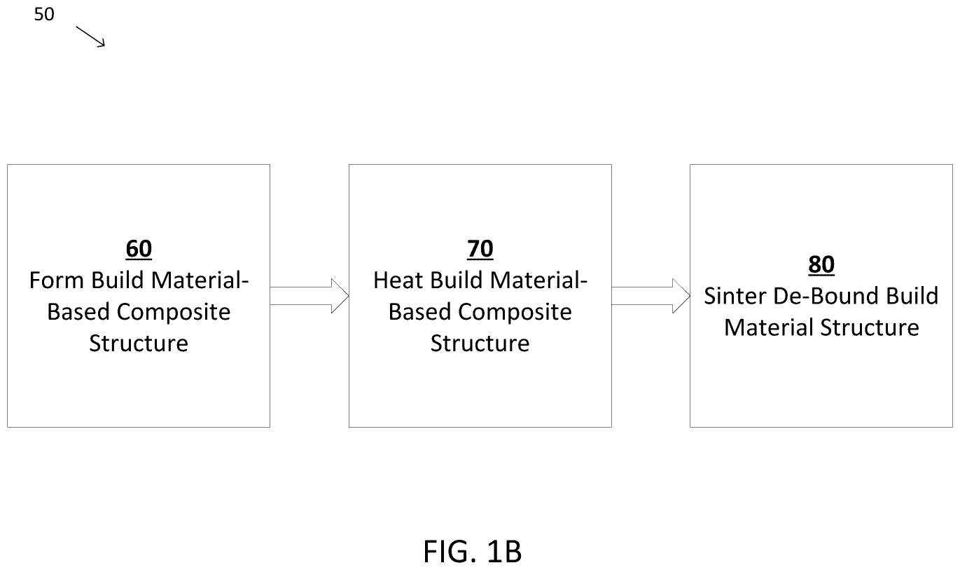

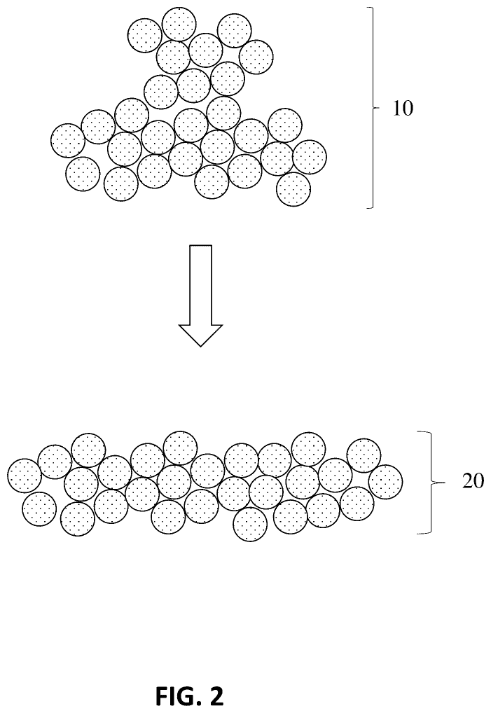

In some embodiments, a method of additive manufacturing comprises forming a build material-based composite structure. FIG. 1A shows a non-limiting diagram of additive manufacturing method 50 comprising step 60 in which a build material-based composite structure is formed. Step 60 may comprise one or more sub-steps of depositing a layer of build material powder, depositing a binder composition, and, in some but not necessarily all embodiments, “curing” deposited components (e.g., via drying and/or cross-linking, according to certain embodiments). For example, step 60 may comprise a step of depositing a layer of build material powder. This step may comprise dispersing a build material powder to form a layer thereof. The build material powder may initially not be in the form of layer (e.g., it may be in the form of a source of build material powder enclosed in a container, in the form of a pile, etc.). FIG. 2 shows one non-limiting embodiment of a method of depositing a layer of build material powder in which a build material powder 10 is deposited to form a layer of build material powder 20. In some embodiments, a build material powder is deposited to form the layer thereof by one or more tools, non-limiting examples of which include rollers, doctor blades, and sifters. Depositing a build material powder to form a layer thereof is typically performed such that the resultant layer of build material powder is formed on a substrate. Appropriate examples of substrates include bases on which the article formed by the additive manufacturing method is designed to be formed (e.g., platforms comprising metals and/or ceramics, sheets comprising metals and/or ceramics) and layers disposed on such bases (e.g., one or more layers of build material powder disposed on a base on which the article formed by the additive manufacturing method is designed to be formed, one or more layers formed in an additive manufacturing process, such as one or more of the layers formed by one or more of the processes described below). Layers disposed on such bases may include layer(s) configured to be incorporated into an article formed by additive manufacturing (e.g., in the case of layer(s) themselves formed by additive manufacturing and/or layer(s) not configured to be incorporated into an article formed by additive manufacturing (e.g., in the case of layer(s) of build material powder).

According to some embodiments, the build material powder 10 may have been previously coated, at least in part, with a precursor material (e.g., comprising a monomer and/or a polymer comprising an unsaturated carbon-carbon bond (e.g., a double bond). According to some embodiments, the build material powder 10 may have been previously coated, at least in part, with a catalyst (e.g., a catalyst for a metathesis chain-growth polymerization reaction such as a ROMP catalyst). According to some embodiments, the build material powder 10 may have been previously coated, at least in part, with a both a precursor material (e.g., comprising a monomer and/or a polymer comprising an unsaturated carbon-carbon bond (e.g., a double bond) and a catalyst (e.g., a catalyst for a metathesis chain-growth polymerization reaction such as a ROMP catalyst).

In some, but not necessarily all embodiments, the build material powder deposited during the formation of the build material-based composite structure in step 60 comprises a metal powder. Referring again to FIG. 2, in some embodiments, build material powder 10, which is deposited to form a layer of build powder 20, is or comprises a copper powder (e.g., comprising copper metal or a copper alloy), a steel powder (e.g., comprising tool steel, 17-4PH stainless, etc.), a noble metal powder (e.g., comprising ruthenium (Ru), rhodium (Rh), palladium (Pd), silver (Ag), osmium (Os), iridium (Ir), platinum (Pt), and/or gold (Au)), a silver powder (e.g., comprising sterling silver), an aluminum or aluminum alloy powder, a titanium or titanium alloy powder, or combinations thereof. In some embodiments, a noble metal powder comprises platinum and/or a platinum alloy (e.g. platinum alloyed with cobalt (Co), ruthenium, iridium). In some instances, a noble metal powder comprises gold metal and/or a gold alloy (e.g., gold alloyed with zinc (Zn), copper, silver, nickel (Ni), iron (Fe), cadmium (Cd), aluminum (Al), palladium (Pd)). In some embodiments in which the metal powder comprises a metal alloy (e.g., a noble metal alloy such as sterling silver), the metal powder comprises a plurality of particles of the metal alloy (e.g., a plurality of sterling silver particles).

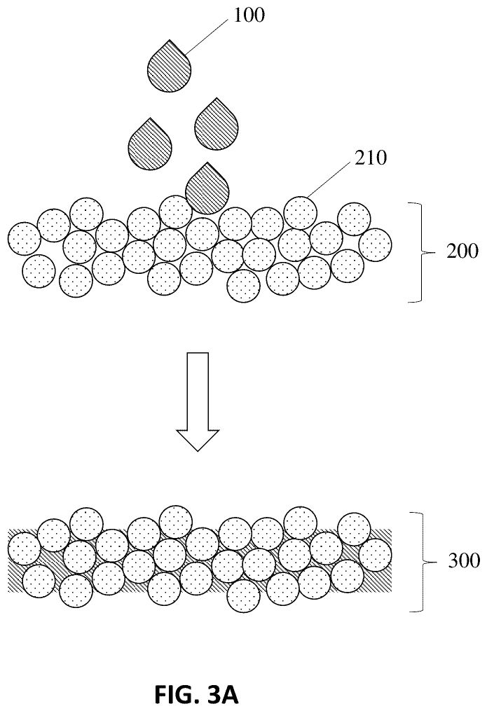

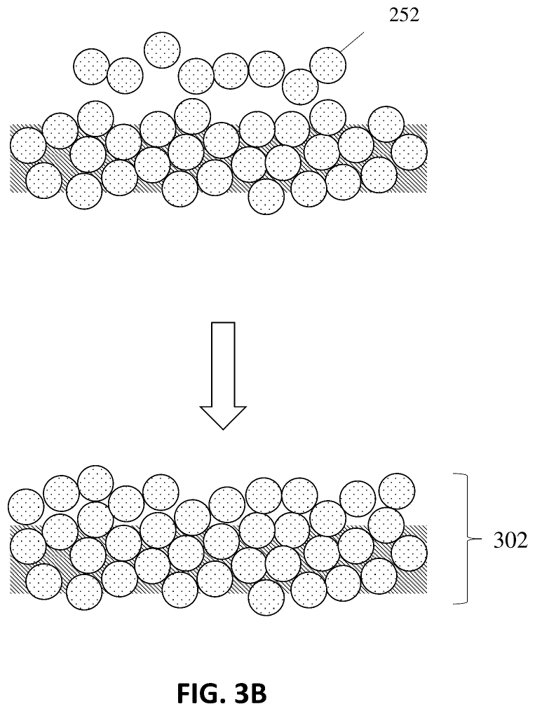

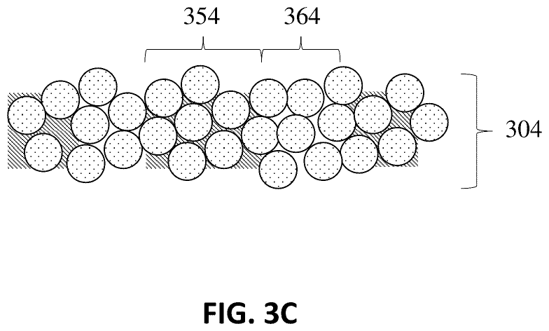

Once a layer of build material powder is obtained, the step of forming the build material-based composite structure (e.g., step 60) may further comprise depositing a binder composition comprising the catalyst, the precursor material and/or an activator of the catalyst (e.g., when the catalyst is a latent catalyst) onto at least a portion of the layer of build material powder. FIG. 3A shows one example of this method step, as it depicts the deposition of a binder composition 100 on a layer 200 of build material powder. The build material powder comprises a plurality 210 of build material particles. The result is a layer 300 comprising particles in contact with binder composition. In some embodiments, like the embodiment shown in FIG. 3A, the binder composition are deposited on the build material powder in the form of droplets, such as in the form of a plurality of droplets formed by a print head. By way of example, a method of additive manufacturing described herein may comprise performing a binder jet printing process.

Step 60 of additive manufacturing method 50 may comprise performing the steps shown in FIGS. 2 and 3A multiple times successively. For instance, a method of additive manufacturing may comprise depositing a first layer of build material powder that is at least partially coated with the precursor material, then depositing a binder composition comprising the catalyst on at least a portion of the first layer of build material powder, and then depositing a second layer of build material powder that is at least partially coated with the precursor material on the first layer of build material powder. In some embodiments, the arrangement is the opposite and, a method of additive manufacturing may comprise depositing a first layer of build material powder that is at least partially coated with the catalyst, then depositing a binder composition comprising the precursor material on at least a portion of the first layer of build material powder, and then depositing a second layer of build material powder that is at least partially coated with the catalyst on the first layer of build material powder. As another example, a method of additive manufacturing may comprise depositing a binder composition comprising the catalyst on at least a portion of a first layer of build material powder that is at least partially coated with the precursor material, then depositing a second layer of build material powder on the first layer of build material powder, and then depositing additional binder composition on at least a portion of the second layer of build material powder. It can be seen that some methods of additive manufacturing may comprise performing these two steps in an alternating manner at least twice, at least three times, at least four times, at least five times, at least ten times, at least a hundred times, or a number of times sufficient to build up a build material-based composite structure.

Methods comprising performing successive steps of depositing a layer of build material powder and depositing a binder composition onto at least a portion of the layer of build material powder may be performed in a variety of manners. By way of example, FIG. 3B shows a method step of depositing a second powder layer 252 on the first powder layer onto which a binder composition had been deposited, thereby forming plurality of layers 302.

As noted elsewhere, in some instances the use of a metathesis chain-growth polymerization reaction may render a separate crosslinking step unnecessary (e.g., due to the strength of the uncured part supplied by the polymerization product). In some embodiments in which curing is performed, the sequential steps of depositing a layer of build material powder at least partially coated with the precursor material (and/or the catalyst) and depositing a binder composition comprising catalyst (and/or the precursor material) thereon may be performed in a manner in which the binder deposited on at least a portion of a first layer of build material powder is not dried or cross-linked prior to depositing a second layer of build material powder on the first layer of build material powder (e.g., the second layer of build material powder is deposited on the first layer of build material powder prior to drying or cross-linking the binder composition). The article formed by such successive steps but without any drying and/or crosslinking) may be referred to elsewhere herein as a “three-dimensional composition,” a “green part,” or simply a “part.” In some embodiments, the sequential steps of depositing a layer of build material powder at least partially coated with the precursor material (and/or the catalyst) and depositing a binder composition thereon may be performed in a manner in which the binder composition comprising the catalyst (and/or precursor material) deposited on at least a portion of a first layer of build material powder is dried and/or cross-linked prior to depositing a second layer of build material powder on the first layer of build material powder. In some such embodiments, drying the binder composition may occur passively at least in part; that is, without a step in which a source of heat is actively applied (examples of applied heating steps being radiative heating (e.g., with an infrared lamp) or convective (e.g., via blowing with hot gas). Passive drying may comprise, for instance, drying at room temperature over some period of time.

It should be noted that some embodiments may comprise both of the above-referenced sequences of steps (e.g., during step 60). For instance, the steps of sequentially depositing a layer of build material powder and then depositing a binder composition onto at least a portion of the layer of build material powder may be repeated a number of times without performing any drying or heating process on the binder composition (e.g., one or more layers of build material powder may be deposited prior to cross-linking or drying the binder composition previously deposited, binder composition may be deposited onto at least a portion of a layer of build material powder deposited prior to the cross-linking or drying of the binder composition previously deposited). These steps may result in the formation of a three-dimensional composition. Then, the binder composition may be dried and/or cross-linked to form a build material-based composite structure from the three-dimensional composition. After which, further steps of sequentially depositing a layer of build material powder and then depositing a binder composition onto at least a portion of the layer of build material powder may be performed thereon. The second three-dimensional composition may also be dried and/or cross-linked. This drying and/or cross-linking may result in the formation of a new build material-based composite structure comprising the prior build material-based composite structure and the dried and/or cross-linked three-dimensional composition formed thereon.

In some embodiments, a step of depositing a binder on at least a portion of a layer of build material powder like that shown in FIG. 3A or FIG. 3B comprises depositing a binder composition on a layer of build material powder such that it contacts some portions of the layer of build material powder and does not contact other portions of the layer of build material powder. The binder composition may penetrate into and/or spread into portions of the layer of build material powder that it contacts. This process may result in the formation of a layer having a morphology like that shown in FIG. 3C. In FIG. 3C, a layer 304 comprises a portion 354 comprising a binder composition, a portion of the layer of build material powder, and a portion 364 comprising a portion of the layer of build material powder but lacking the binder composition. The portions of the layer of build material powder through which the binder composition has penetrated and/or spread may be adhered together by one or more components of the binder composition (e.g., a polymer) upon deposition thereof and/or during later processing steps. The portions of the layer of build material powder through which the binder composition has not penetrated or spread may remain unadhered to each other.

During formation of a three-dimensional composition, deposition of a binder composition on a layer or build material powder may also comprise depositing a portion of the binder composition onto another layer positioned beneath the layer (e.g., binder composition is deposited on a second layer and a first layer beneath the second layer). Advantageously, this may adhere together layers in the three-dimensional composition with the layers to which they are directly adjacent, which may result in the formation of a three-dimensional object, build material-based composite structure, or combination of build material-based composite structures adhered together in all three dimensions and/or having a continuous morphology.

As described above, some methods of additive manufacturing comprise forming a build material-based composite structure (e.g., from a layer comprising a binder composition, from a three-dimensional composition) (e.g., in a process comprising drying and/or cross-linking a binder composition. As also described above, the binder composition comprising the catalyst (and/or the precursor material) may be a binder composition present in a three-dimensional composition and/or may be a binder composition present in a layer disposed on a build material-based composite structure.

As described above, step 60 of additive manufacturing method 50, corresponding to forming a build material-based composite structure, may, in some but not necessarily all embodiments, comprise a step of drying and/or cross-linking the binder composition (e.g., to “cure” the build material-based composite structure). Drying the binder composition may comprise exposing the binder composition to a stimulus that causes one or more volatile components therein to evaporate (e.g., free water, organic solvents, volatile pH modifiers). Other, non-volatile and/or less volatile components of the binder composition may not be removed by a drying process (e.g., bound water, a polymer, a cross-linking agent).

As noted elsewhere in this disclosure, metathesis chain-growth polymerization reactions (e.g., ROMP reactions) involving the coating and/or the binder composition may render a separate cross-linking step unnecessary in some embodiments. However, in some embodiments a cross-linking step is performed. Cross-linking the binder composition may comprise exposing the binder composition to a stimulus that causes one or more portions thereof to undergo a cross-linking reaction (e.g., a polymer, a cross-linking agent). Non-limiting examples of suitable stimuli include heat and light (e.g., microwave radiation, UV light). As such, in some embodiments, step 60 includes a heating step. Heat transfer during the heating step may include any combination of conduction, convection and/or radiation. Convective heat transfer may include, but is not limited to, forced convection through the powder bed. Heat and/or light stimuli may be suitable both for drying the binder composition and cross-linking the binder composition; other such stimuli may only be suitable for one or the other. In some embodiments, a binder composition may be dried and then cross-linked. The drying step may comprise removing one or more components that would interfere with the cross-linking step. For instance, a drying step may comprise removing water (e.g., water that causes the equilibrium of the cross-linking reaction to favor breaking cross-links instead of forming cross-links) and/or may comprise removing an optional pH modifier, if present (e.g., a pH modifier that would interfere with the cross-linking reaction).

Additionally, or alternatively to drying and/or cross-linking, forming a build material-based composite structure in step 60 may comprise heating of the build material powder and binder composition to cause or accelerate the metathesis chain-growth polymerization reaction (e.g., an olefin metathesis polymerization such as ROMP) involving the monomer and/or polymer of the precursor material and catalyzed by the catalyst. For instance, an additive fabrication device may comprise one or more heaters arranged to provide heat to at least the upper layer of build material during fabrication.

In some embodiments, heating of the build material powder and binder composition (e.g., as part of a curing process to cause or accelerate the metathesis chain-growth polymerization reaction) comprises heating an environment in which a three-dimensional composition is positioned to a temperature of greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., greater than or equal to 220° C., greater than or equal to 230° C., or greater than or equal to 240° C. In some embodiments, heating of the build material powder and binder composition (e.g., as part of a curing process to cause or accelerate the metathesis chain-growth polymerization reaction) comprises heating an environment in which the three-dimensional composition is positioned to a temperature of less than or equal to 250° C., less than or equal to 240° C., less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., or less than or equal to 100° C. Combinations of the above-referenced ranges are also possible (e.g., greater than or equal to 90° C. and less than or equal to 250° C., greater than or equal to 120° C. and less than or equal to 220° C.). Other temperatures are also possible. The temperature chosen for the environment during the heating may in some cases depend on the composition of the environment. The temperature of an environment may be determined by use of a thermocouple positioned in the environment.

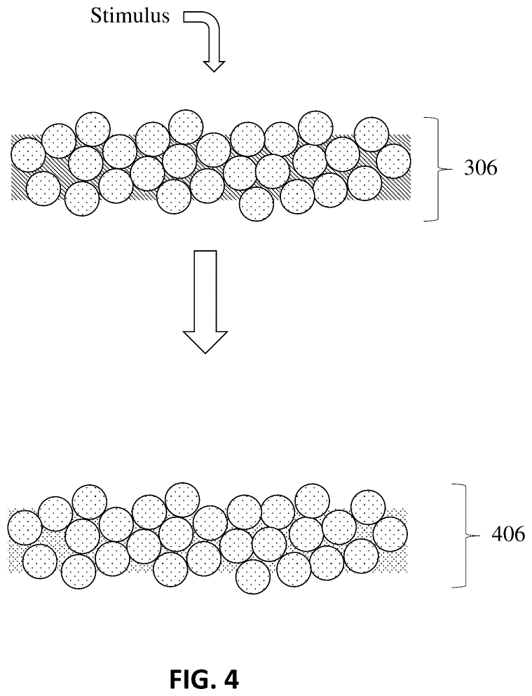

FIG. 4 shows one example of a step of drying, heating and/or cross-linking a binder composition, in which a stimulus is applied to a layer 306 to form a build material-based composite structure 406. In some embodiments, a method like that shown in FIG. 4 is performed on a single layer comprising a layer of build material particles and a binder (and/or a layer of build material particles on which a binder composition is disposed). In some embodiments, a method like that shown in FIG. 4 is performed on a series of such layers disposed on each other in a three-dimensional composition simultaneously.

In some embodiments, a build material-based composite structure may undergo one or more further steps. By way of example, portion(s) of a layer of build material powder (and/or layers of build material powder forming a build material powder bed) onto which the binder composition has been deposited may be incorporated into the build material-based composite structure while other portion(s) (e.g., portions onto which the binder composition was not deposited) may not be incorporated into the build material-based composite structure. One or more portion(s) of the layer(s) of build material powder and/or build material powder bed not incorporated into the build material-based composite structure may be removed therefrom (e.g., following step 60 in FIG. 1A). This may be accomplished by, for example, removing the build material-based composite structure from a powder bed. Removing the build material powder not incorporated into the build material-based composite structure may include a “depowdering” process. A depowdering process may be accomplished using any of a variety of techniques, including, but not limited to, manual removal (e.g., by brushing excess powder), directed gas stream flow, and collision with solid particles (e.g., particles of solid CO₂) to dislodge unincorporated build material powder from the build material-based composite structure.

In some embodiments, the additive manufacturing method includes a step of heating the build material-based composite structure. For example, following step 60 in which the build material-based composite structure is formed, subsequently step 70 may be performed, in which the build material-based composite structure is heated. Heating in step 70 may be performed to debind the build material-based composite structure and/or to cause or accelerate the metathesis chain-growth polymerization reaction.

It should be understood that one or more intervening steps may be performed between step 60 and step 70, such as the depowdering step described above. While the heating to de-bind of step 70 is optional, it may, in certain cases, be useful for removing some or all of the binder from the build material-based composite structure. Removal of the binder (e.g., in step 70) may, in some cases, advantageously contribute to high build material densities in the finished product of the additive manufacturing method.

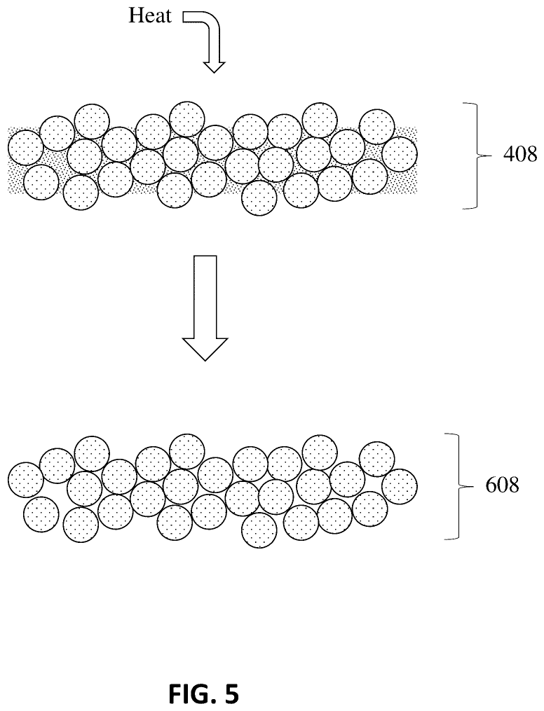

The heating (e.g., in step 70) may comprise positioning the build material-based composite structure in an environment at a temperature that results in the removal of one or more components of the binder composition and/or a polymer product resulting from the metathesis chain-growth polymerization reaction previously retained in the composite structure. For instance, the heating may remove a polymer from the binder composition retained in the composite structure and/or one or more other components of the binder composition not removed from the composite structure by prior drying and/or cross-linking steps. In some embodiments, heating the composite structure may cause thermal decomposition of these components of the binder composition that are then volatilized or retained as solids (e.g., as char) positioned within the resultant structure. The resultant structure may also be referred to herein as a “de-bound build material structure”. FIG. 5 shows one example of a heating step, in which heat is applied to a build material-based composite structure 408 to form a de-bound build material structure 608. During a heating step, the particles present in the build material-based composite structure may adhere together directly as the portion(s) of the binder composition are being removed.

During this heating process (e.g., during step 70), a temperature is typically selected that promotes volatilization (e.g., evaporation, thermal decomposition and/or degradation) of the binder and/or binder composition. However, in some cases the temperature should not be so high as to cause deleterious processes such as oxide formation when certain build materials are present. In some embodiments, an environment in which a build material-based composite structure is positioned is heated to a temperature of greater than or equal to 220° C., greater than or equal to 230° C., greater than or equal to 240° C., greater than or equal to 250° C., greater than or equal to 275° C., greater than or equal to 300° C., greater than or equal to 350° C., greater than or equal to 400° C., or greater than or equal to 450° C. In some embodiments, an environment in which a build material-based composite structure is positioned is heated to a temperature of less than or equal to 450° C., less than or equal to 400° C., less than or equal to 350° C., less than or equal to 300° C., less than or equal to 280° C., less than or equal to 275° C., less than or equal to 250° C., less than or equal to 240° C., or less than or equal to 230° C. Combinations of the above-referenced ranges are also possible (e.g., greater than or equal to 220° C. and less than or equal to 450° C., or greater than or equal to 240° C. and less than or equal to 280° C.). Other ranges are also possible. The temperature of an environment may be determined by use of a thermocouple positioned in the environment.

It should be understood that some heating steps may comprise heating an environment in which the build material-based composite structure is positioned to two or more temperatures in sequence. For instance, a heating step may comprise heating a build material-based composite structure at one temperature at which one portion of the binder is expected to degrade (e.g., based on a thermogravimetric analysis performed on the binder) and then heating the build material-based composite structure at another temperature at which another portion of the binder is expected to degrade (e.g., based on a thermogravimetric analysis performed on the binder). These temperatures may be successively increasing (e.g., each temperature to which the build material-based composite structure is heated during the heating step may be higher than the previous temperature at which the build material-based composite structure was heated during the heating step). Some such heating steps may comprise heating the build material-based composite structure at three, four, five, or even more temperatures in sequence. Some or all of the temperatures may be within one or more of the above-described ranges.

In some embodiments, a heating step (e.g., during step 70) is performed in a manner that reduces the tendency of the build material-based composite structure to form cracks. For instance, the heating step may be performed in a manner such that changes between temperatures are accomplished relatively slowly. In some embodiments, a heating step is performed such that the change in temperature of the environment in which the build material-based composite structure is positioned is less than or equal to 2° C./min, less than or equal to 1.5° C./min, less than or equal to 1° C./min, less than or equal to 0.75° C./min, less than or equal to 0.5° C./min, or less than or equal to 0.25° C./min. In some embodiments, a heating step is performed such that that the change in temperature of the environment in which the build material-based composite structure is positioned is greater than or equal to 0.1° C./min, greater than or equal to 0.25° C./min, greater than or equal to 0.5° C./min, greater than or equal to 0.75° C./min, greater than or equal to 1° C./min, or greater than or equal to 1.5° C./min. Combinations of the above-referenced ranges are also possible (e.g., greater than or equal to 2° C./min and less than or equal to 0.1° C./min). Other ranges are also possible. In some embodiments, the temperature of the environment in which the build material-based composite structure is positioned is either constant or changes at a rate in one or more of the ranges described above throughout the heating step. In some embodiments, the heating step comprises a change in temperature at a rate in one or more of the ranges described above but also comprises further changes in temperature (e.g., at a rate in one or more of the ranges described above, at a rate outside of the ranges described above).

In some embodiments, during a heating step (e.g., step 70 in FIG. 1A), the pressure of the environment to which the build material-based composite structure is exposed is set to a partial vacuum to contribute to the removal of the decomposition products from the build material-based composite structure. It should be understood that in a partial vacuum, one or more gases may be present, but the environment has a pressure lower than ambient pressure. In some embodiments, the pressure of the environment is greater than or equal to 10⁻⁵ bar, greater than or equal to 10⁻⁴ bar, greater than or equal to 10⁻³ bar, greater than or equal to 10⁻² bar, greater than or equal to 10⁻¹ bar, greater than or equal to 1 bar, greater than or equal to 10 bar, greater than or equal to 20 bar, or greater than or equal to 50 bar. In some embodiments, the pressure is less than or equal to 70 bar, less than or equal to 50 bar, less than or equal to 20 bar, less than or equal to 10 bar, less than or equal to 1 bar, less than or equal to 10⁻¹ bar, less than or equal to 10⁻² bar, less than or equal to 10⁻³ bar, less than or equal to 10⁻⁴ bar, less than or equal to 10⁻⁵ bar, less than or equal to 10⁻⁶ bar, less than or equal to 10⁻⁷ bar, less than or equal to 10⁻⁸ bar, less than or equal to 10⁻⁹ bar, or less than or equal to 10⁻¹⁰ bar. Combinations of the above-referenced ranges are also possible (e.g., greater than or equal to 10⁻¹¹ bar and less than or equal to 70 bar, greater than or equal to 10⁻¹¹ bar and less than or equal to 10⁻³ bar, greater than or equal to 10⁻³ bar and less than or equal to 70 bar, greater than or equal to 10⁻³ bar and less than or equal to 1 bar, or greater than or equal to 10⁻³ bar and less than or equal to 10⁻¹ bar). Other ranges are also possible. The pressure may be determined by a pressure gauge. In some embodiments, the pressure of the environment to which the build material-based composite structure is exposed is cycled between atmospheric pressure and a pressure in one or more of the above-referenced ranges.

In some embodiments, an environment to which a build material-based composite structure is exposed during a heating step is a gaseous environment, where the environment comprises one or more gases. For instance, in some embodiments, the relevant environment may comprise one or more species that are reactive (e.g., with one or more components of the binder) at the temperature to which the environment is heated. For example, the relevant environment may be an oxidative environment (e.g., it may comprise air). An oxidative environment generally refers to one comprising oxidizing species, including but not limited to oxygen gas (O₂), ozone (O₃), gaseous hydrogen peroxide (H₂O₂), other peroxides (e.g., sodium peroxide (Na₂O₂), barium peroxide (BaO₂), magnesium peroxide (MgO₂), gaseous nitric acid (HNO₃), and carbon dioxide (CO₂).

In some embodiments in which the environment in which a build material-based composite structure is heated in an oxidative environment, the environment is a gaseous environment having a suitable oxygen (O₂) content. For example, in some embodiments, an oxidative environment in which a build material-based composite structure is heated has an oxygen content of greater than or equal to 10%, greater than or equal to 12%, greater than or equal to 15%, greater than or equal to 18%, greater than or equal to 20% by volume, greater than or equal to 30%, greater than or equal to 50%, greater than or equal to 75%, or greater. In some cases, an oxidative environment in which a build material-based composite structure is heated has an oxygen content of less than or equal to 100%, less than or equal to 90%, less than or equal to 75%, less than or equal to 60%, less than or equal to 50%, less than or equal to 40%, less than or equal to 30%, less than or equal to 25%, less than or equal to 23%, less than or equal to 22%, less than or equal to 21%, less than or equal to 20%, less than or equal to 18%, less than or equal to 15%, or less than or equal to 10% by volume. Combinations of these ranges are possible. For example, in some embodiments, an oxidative environment in which a build material-based composite structure is heated has an oxygen content of greater than or equal to 10% and less than or equal to 100% or greater than or equal to 10% and less than or equal to 23% by volume. In some embodiments, the oxidative environment is a gaseous environment that is or comprises air.

In some embodiments in which the environment in which a build material-based composite structure is heated in an oxidative environment, the environment is a gaseous environment having oxygen (O₂) at a suitable partial pressure. For example, in some embodiments, an oxidative environment in which a build material-based composite structure is heated has an oxygen partial pressure of greater than or equal to 10⁻⁵ bar, greater than or equal to 10⁻⁴ bar, greater than or equal to 10⁻³ bar, greater than or equal to 10⁻² bar, greater than or equal to 10⁻¹ bar, 2×10⁻¹ bar, greater than or equal to 1 bar, greater than or equal to 10 bar, greater than or equal to 20 bar, or greater than or equal to 50 bar. In some cases, an oxidative environment in which a build material-based composite structure is heated has an oxygen partial pressure of less than or equal to 70 bar, less than or equal to 50 bar, less than or equal to 20 bar, less than or equal to 10 bar, less than or equal to 1 bar, less than or equal to 2×10⁻¹ bar, less than or equal to 10⁻¹ bar, less than or equal to 10⁻² bar, less than or equal to 10⁻³ bar, or less than or equal to 10⁻⁴ bar. Combinations of these ranges are possible. For example, in some embodiments, an oxidative environment in which a build material-based composite structure is heated has an oxygen partial pressure of greater than or equal to 10⁻⁵ bar and less than or equal to 70 bar.

In some instances, step 70 further comprises a step of exposing the resulting de-bound build material structure to a reductive environment (e.g., following a heating step in which the build material-based composite is exposed to an oxidative environment). The reductive environment may comprise hydrogen (H₂). For instance, in some embodiments, a reductive environment in which a de-bound build material structure is heated after the oxidative de-binding is a gaseous environment having a hydrogen content of greater than or equal to 2 vol %, greater than or equal to 4 vol %, greater than or equal to 6 vol %, greater than or equal to 8 vol %, greater than or equal to 10 vol %, greater than or equal to 20 vol %, greater than or equal to 30 vol %, greater than or equal to 50 vol %, greater than or equal to 75 vol %, greater than or equal to 90 vol %, greater than or equal to 95 vol %, or higher. The reductive gaseous environment in which the de-bound build material structure is heated may have a hydrogen content of less than or equal to 100 vol %, less than or equal to 99 vol %, less than or equal to 95 vol %, less than or equal to 90 vol %, less than or equal to 75 vol %, less than or equal to 50 vol %, less than or equal to 40 vol %, less than or equal to 30 vol %, less than or equal to 20 vol %, less than or equal to 10 vol %, less than or equal to 8 vol %, less than or equal to 6 vol %, or less than or equal to 4 vol % hydrogen. Combinations of the above-referenced ranges are also possible (e.g., a hydrogen content of greater than or equal to 2 vol % and less than or equal to 100 vol %, or a hydrogen content of greater than or equal to 2 vol % and less than or equal to 10 vol %). Other ranges are also possible.

In some embodiments, a reductive gaseous environment in which a de-bound build material structure is heated after the oxidative de-debinding has a partial pressure of hydrogen of greater than or equal to 10⁻⁵ bar, greater than or equal to 10⁻⁴ bar, greater than or equal to 10⁻³ bar, greater than or equal to 10⁻² bar, greater than or equal to 10⁻¹ bar, greater than or equal to 1 bar, greater than or equal to 10 bar, greater than or equal to 20 bar, or greater than or equal to 50 bar. In some embodiments, a reductive gaseous environment in which a de-bound build material structure is heated after the oxidative de-debinding has a partial pressure of hydrogen of less than or equal to 70 bar, less than or equal to 50 bar, less than or equal to 20 bar, less than or equal to 10 bar, less than or equal to 1 bar, less than or equal to 10⁻¹ bar, less than or equal to 10⁻² bar, less than or equal to 10⁻³ bar, or less than or equal to 10⁻⁴ bar. Combinations of these ranges (e.g., greater than or equal to 10⁻⁵ bar hydrogen and less than or equal to 70 bar hydrogen) are possible.

As one non-limiting example, a build material-based composite structure may be heated as part of a de-binding step in an oxidative gaseous environment (e.g., air) having a temperature of greater than or equal to 220° C. and less than or equal to 450° C. to form a de-bound build material structure, and then the environment may be changed a second environment that is a reductive gaseous environment (e.g., having a hydrogen content of greater than or equal to 2 vol % and up to 10 vol %, or even up to 100 vol % hydrogen) having a temperature that is also of greater than or equal to 220° C. and less than or equal to 450° C. The de-bound build material structure may be held in the second environment for greater than or equal to 1 hour and less than or equal to 6 hours, for example.

A build material-based composite structure may be heated (e.g., in an oxidative environment) for a variety of suitable amounts of time. In some embodiments, an environment in which a build material-based composite material is positioned (e.g., an oxidative environment) is heated for a time period of greater than or equal to 15 minutes, greater than or equal to 0.5 hours, greater than or equal to 1 hour, greater than or equal to 1.5 hours, greater than or equal to 2 hours, greater than or equal to 2.5 hours, greater than or equal to 3 hours, greater than or equal to 4 hours, greater than or equal to 4.5 hours, greater than or equal to 5 hours, greater than or equal to 5.5 hours, greater than or equal to 6 hours, greater than or equal to 6.5 hours, greater than or equal to 7 hours, greater than or equal to 7.5 hours, greater than or equal to 8 hours, greater than or equal to 8.5 hours, greater than or equal to 9 hours, greater than or equal to 9.5 hours, greater than or equal to 10 hours, greater than or equal to 15 hours, greater than or equal to 20 hours, or greater. In some embodiments, an environment in which a build material-based composite material is positioned is heated for a time period of less than or equal to 72 hours, less than or equal to 48 hours, less than or equal to 36 hours, less than or equal to 24 hours, less than or equal to 20 hours, less than or equal to 15 hours, less than or equal to 10 hours, less than or equal to 9.5 hours, less than or equal to 9 hours, less than or equal to 8.5 hours, less than or equal to 8 hours, less than or equal to 7.5 hours, less than or equal to 7 hours, less than or equal to 6.5 hours, less than or equal to 6 hours, less than or equal to 5.5 hours, or less than or equal to 5 hours. Combinations of the above-referenced ranges are also possible (e.g., greater than or equal to 15 minutes and less than or equal to 1 day, or greater than or equal to 4 hours and less than or equal to 10 hours). Other ranges are also possible.

In some embodiments, heating a build material-based composite material comprises heating the environment in which the build material-based composite material is positioned to one temperature in one or more of the above-referenced ranges and holding the temperature of the environment thereat for an amount of time in one of the above-referenced ranges. In some embodiments, heating a build material-based composite material comprises heating an environment in which the build material-based composite is positioned to two or more temperatures in the above-referenced ranges sequentially and holding the temperature of the environment at each of the two or more temperatures. In such embodiments, the relevant environment may be held at each of the relevant temperatures for a period of time in one or more of the above-referenced ranges and/or may be heated such that the total time it is held at all of the relevant temperatures is in one or more of the above-referenced ranges.

Non-limiting examples of suitable environments in which a build material-based composite structure may be positioned during heating include suitable chambers such as an oven.

In some embodiments where the additive manufacturing method comprises heating a build material-based composite structure in a first, oxidative environment in a chamber (e.g., oven) to de-bind the build material-based composite structure and then comprises holding the resulting de-bound build material structure in a second environment (e.g., a reductive gaseous environment), the holding step can also be performed in the same chamber as the first, oxidative environment. For example, the oxidizing gas of the first environment may be replaced with a reducing gas (e.g., hydrogen) by flowing in a reducing gas, or evacuating the chamber and back-filling with the reducing gas.

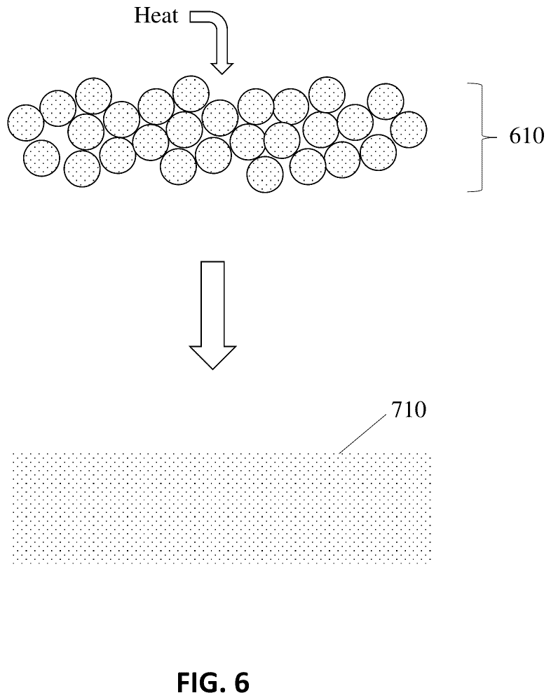

In some embodiments, the additive manufacturing method includes a step of sintering the de-bound build material structure to form a build material object. For example, FIG. 1B shows an exemplary embodiment of additive manufacturing method 50 in which a step 80 of sintering a de-bound build material structure is performed following step 60 and step 70. The sintering step may be performed by heating the de-bound build material structure. In some embodiments, sintering the de-bound build material structure (e.g., by heating) forms a build material object. The heating process of the sintering step (e.g., step 80) may comprise heating an environment in which the de-bound build material structure is positioned to a temperature that allows for diffusion of build material components within the de-bound build material structure but that does not melt the de-bound build material structure to an undesirable extent. For example, this heating step may comprise heating the environment to a temperature that promotes sintering of the de-bound build material structure. Advantageously, diffusion that occurs during sintering may further bond together the resultant build material object and/or may reduce (and/or eliminate) any porosity present in de-bound build material structure. This diffusion may also cause de-bound build material structure to densify, which may enhance its surface finish, mechanical properties, and/or electrical conductivity. FIG. 6 shows one example of a step of heating a de-bound build material structure, in which heat is applied to a de-bound build material structure 610 to form a build material object 710.

The temperature of the environment in which the sintering step is performed may be chosen based on one or more properties of the build material and/or build material alloy (e.g., copper or a noble metal such as silver, platinum, gold) present in the de-bound build material structure. For example, during this heating process, it may be desirable for the de-bound build material structure to undergo sintering without undergoing appreciable melting, and an appropriate temperature should be chosen accordingly. Heating may be performed using any of a variety of techniques, such as radiative heating, convective heating, conduction, or combinations thereof. For example, in some embodiments, the sintering is performed in a thermal radiation oven. In certain other embodiments, the sintering is performed in an oven configured to reach relatively high temperatures, such as a tube furnace. In some embodiments, an environment in which a de-bound build material structure is positioned is heated to a temperature of greater than or equal to 750° C., greater than or equal to 800° C., greater than or equal to 850° C., greater than or equal to 900° C., greater than or equal to 950° C., greater than or equal to 1000° C., greater than or equal to 1050° C., greater than or equal to 1100° C., greater than or equal to 1150° C., greater than or equal to 1200° C., greater than or equal to 1250° C., greater than or equal to 1300° C., greater than or equal to 1350° C., greater than or equal to 1400° C., greater than or equal to 1500° C., or greater than or equal to 1600° C. In some embodiments, an environment in which a de-bound build material structure is positioned is heated to a temperature of less than or equal to 1700° C., less than or equal to 1600° C., less than or equal to 1500° C., less than or equal to 1400° C., less than or equal to 1350° C., less than or equal to 1300° C., less than or equal to 1250° C., less than or equal to 1200° C., less than or equal to 1150° C., less than or equal to 1100° C., less than or equal to 1050° C., less than or equal to 1000° C., less than or equal to 950° C., less than or equal to 900° C., less than or equal to 850° C., or less than or equal to 800° C. Combinations of the above-referenced ranges are also possible (e.g., greater than or equal to 750° C. and less than or equal to 1700° C., greater than or equal to 750° C. and less than or equal to 1200° C., greater than or equal to 750° C. and less than or equal to 900° C., greater than or equal to 800° C. and less than or equal to 1000° C., or greater than or equal to 1400° C. and less than or equal to 1700° C.). Other ranges are also possible. The temperature of an environment may be determined by use of a thermocouple positioned in the environment.

In some embodiments, during the heating step of a sintering process (e.g., during step 80 in FIG. 1B), the pressure of the environment to which the de-bound build material structure is exposed is set to a full vacuum or a partial vacuum to contribute to the removal of, for example, decomposition products from the build material-based composite structure that may still be present in the de-bound build material structure. In some embodiments, the pressure is greater than or equal to 10⁻¹¹ bar, greater than or equal to 10⁻¹⁰ bar, greater than or equal to 10⁻⁹ bar, greater than or equal to 10⁻⁸ bar, greater than or equal to 10⁻⁷ bar, greater than or equal to 10⁻⁶ bar, greater than or equal to 10⁻⁵ bar, greater than or equal to 10⁻⁴ bar, greater than or equal to 10⁻³ bar, greater than or equal to 10⁻² bar, greater than or equal to 10⁻¹ bar, greater than or equal to 1 bar, greater than or equal to 10 bar, greater than or equal to 20 bar, or greater than or equal to 50 bar. In some embodiments, the pressure is less than or equal to 70 bar, less than or equal to 50 bar, less than or equal to 20 bar, less than or equal to 10 bar, less than or equal to 1 bar, less than or equal to 10⁻¹ bar, less than or equal to 10⁻² bar, less than or equal to 10⁻³ bar, less than or equal to 10⁻⁴ bar, less than or equal to 10⁻⁵ bar, less than or equal to 10⁻⁶ bar, less than or equal to 10⁻⁷ bar, less than or equal to 10⁻⁸ bar, less than or equal to 10⁻⁹ bar, or less than or equal to 10⁻¹⁰ bar. Combinations of the above-referenced ranges are also possible (e.g., greater than or equal to 10⁻¹¹ bar and less than or equal to 70 bar, greater than or equal to 10⁻¹¹ bar and less than or equal to 10⁻³ bar, greater than or equal to 10⁻³ bar and less than or equal to 70 bar, greater than or equal to 10⁻³ bar and less than or equal to 1 bar, or greater than or equal to 10⁻³ bar and less than or equal to 10⁻¹ bar). Other ranges are also possible. The pressure may be determined by a pressure gauge. In some embodiments, the pressure of the environment to which the de-bound build material structure is exposed is cycled between atmospheric pressure and a pressure in one or more of the above-referenced ranges.

In some embodiments, an environment to which a de-bound build material structure is exposed during a heating step of a sintering process is a gaseous environment, where the environment comprises one or more gases. For instance, in some embodiments, the relevant environment may comprise one or more species that are reactive at the temperature to which the environment is heated. For example, the relevant environment may be an oxidative environment (e.g., it may comprise air) or a reductive environment. A reductive environment generally refers to one containing reducing species, such as hydrogen (e.g. pure hydrogen, a mixture of hydrogen and argon comprising 1 volume percent (vol %) to 6 vol % hydrogen, a mixture of hydrogen and argon comprising up to 10 vol % hydrogen). In some embodiments, the relevant environment is an inert environment. By way of example, the relevant environment may comprise, consist of, and/or consist essentially of inert gases, such as nitrogen, argon, and/or helium.

In some embodiments in which the environment in which a de-bound build material structure is heated in an oxidative environment (e.g., during sintering step 80), the environment is a gaseous environment having a suitable oxygen (O₂) content. For example, in some embodiments, an oxidative environment in which a de-bound build material structure is heated has an oxygen content of greater than or equal to 10%, greater than or equal to 12%, greater than or equal to 15%, greater than or equal to 18%, greater than or equal to 20% by volume, greater than or equal to 30%, greater than or equal to 50%, greater than or equal to 75%, or greater by volume. In some cases, an oxidative environment in which a de-bound build material structure is heated has an oxygen content of less than or equal to 100%, less than or equal to 90%, less than or equal to 75%, less than or equal to 60%, less than or equal to 50%, less than or equal to 40%, less than or equal to 30%, less than or equal to 25%, less than or equal to 23%, less than or equal to 22%, less than or equal to 21%, less than or equal to 20%, less than or equal to 18%, less than or equal to 15%, or less than or equal to 10% by volume. Combinations of these ranges are possible. For example, in some embodiments, an oxidative environment in which a de-bound build material structure is heated has an oxygen content of greater than or equal to 10% and less than or equal to 100% by volume, or greater than or equal to 10% and less than or equal to 23% by volume. In some embodiments, the oxidative environment is a gaseous environment that is or comprises air.

In some embodiments in which the environment in which a de-bound build material-structure is heated in an oxidative environment, the environment is a gaseous environment having oxygen (O₂) at a suitable partial pressure. For example, in some embodiments, an oxidative environment in which a de-bound build material structure is heated has an oxygen partial pressure of greater than or equal to 10⁻⁵ bar, greater than or equal to 10⁻⁴ bar, greater than or equal to 10⁻³ bar, greater than or equal to 10⁻² bar, greater than or equal to 10⁻¹ bar, 2×10⁻¹ bar, greater than or equal to 1 bar, greater than or equal to 10 bar, greater than or equal to 20 bar, or greater than or equal to 50 bar. In some cases, an oxidative environment in which a de-bound build material structure is heated has an oxygen partial pressure of less than or equal to 70 bar, less than or equal to 50 bar, less than or equal to 20 bar, less than or equal to 10 bar, less than or equal to 1 bar, less than or equal to 2×10⁻¹ bar, less than or equal to 10⁻¹ bar, less than or equal to 10⁻² bar, less than or equal to 10⁻³ bar, or less than or equal to 10⁻⁴ bar. Combinations of these ranges are possible. For example, in some embodiments, an oxidative environment in which a de-bound structure is heated has an oxygen partial pressure of greater than or equal to 10⁻⁵ bar and less than or equal to 70 bar.

In some embodiments in which the environment in which a de-bound build material structure is heated in a reductive environment (e.g., during sintering step 80), the environment is a gaseous environment having a suitable hydrogen (H₂) content. For instance, in some embodiments, an environment in which a de-bound build material structure is heated during sintering is a gaseous environment having a hydrogen content of greater than or equal to 2 vol %, greater than or equal to 4 vol %, greater than or equal to 6 vol %, greater than or equal to 8 vol %, greater than or equal to 10 vol %, greater than or equal to 20 vol %, greater than or equal to 30 vol %, greater than or equal to 50 vol %, greater than or equal to 75 vol %, greater than or equal to 90 vol %, greater than or equal to 95 vol %, or higher. The reductive gaseous environment in which the de-bound build material structure is heated during sintering may have a hydrogen content of less than or equal to 100 vol %, less than or equal to 99 vol %, less than or equal to 95 vol %, less than or equal to 90 vol %, less than or equal to 75 vol %, less than or equal to 50 vol %, less than or equal to 40 vol %, less than or equal to 30 vol %, less than or equal to 20 vol %, less than or equal to 10 vol %, less than or equal to 8 vol %, less than or equal to 6 vol %, or less than or equal to 4 vol % hydrogen. Combinations of the above-referenced ranges are also possible (e.g., a hydrogen content of greater than or equal to 2 vol % and less than or equal to 100 vol %, or a hydrogen content of greater than or equal to 2 vol % and less than or equal to 10 vol %). Other ranges are also possible.

In some embodiments, a reductive gaseous environment in which a de-bound build material structure is heated during sintering has a partial pressure of hydrogen of greater than or equal to 10⁻⁵ bar, greater than or equal to 10⁻⁴ bar, greater than or equal to 10⁻³ bar, greater than or equal to 10⁻² bar, greater than or equal to 10⁻¹ bar, greater than or equal to 1 bar, greater than or equal to 10 bar, greater than or equal to 20 bar, or greater than or equal to 50 bar. In some embodiments, a reductive gaseous environment in which a de-bound build material structure is heated during sintering has a partial pressure of hydrogen of less than or equal to 70 bar, less than or equal to 50 bar, less than or equal to 20 bar, less than or equal to 10 bar, less than or equal to 1 bar, less than or equal to 10⁻¹ bar, less than or equal to 10⁻² bar, less than or equal to 10⁻³ bar, or less than or equal to 10⁻⁴ bar. Combinations of these ranges (e.g., greater than or equal to 10⁻⁵ bar hydrogen and less than or equal to 70 bar hydrogen) are possible.

While in some embodiments the various heating steps are each performed in a different chamber (e.g., oven), in other embodiments multiple heating steps can be performed in the same chamber. For example, in certain instances, some or all the heating for de-binding (e.g., step 70 in FIGS. 1A-1B) occurs in a chamber, and some or all of the sintering (e.g., step 80 in FIG. 1B) also occurs in the chamber (e.g., the same oven). Heating for de-binding and sintering may be performed in the same chamber even in instances in which de-binding and sintering are performed in different environments. For example, a single chamber may be configured to heat contents of the chamber within first and second environments having different temperatures and/or comprising different constituent gas(es). Surprisingly, it has been observed that a single chamber may be configured to successfully de-bind and sinter even in instances in which de-binding occurs a first environment having a first type of reactivity (e.g., oxidative) and sintering in a second environment having a second, different type of reactivity (e.g., reductive). For example, the chamber may comprise components that have little to no reactivity with either oxidative gases (e.g., oxygen) or reductive gases (e.g., hydrogen). In at least some instances, performing different heating steps (e.g., de-binding, sintering) in the same chamber (e.g., oven) increases the efficiency and/or speed of the overall additive manufacturing process. For example, because de-bound build material structures produced through de-binding do not need to be removed from one device and supplied to another before sintering, this time may be saved. Additionally, in some instances use of the same chamber for different heating steps reduces complexity and cost by reducing the number of process steps, separate components/apparatuses, and overall system footprint.

In some embodiments, an additive manufacturing method comprises heating a build material-based composite structure (e.g., comprising a build material powder) in a first environment in a chamber to form a de-bound build material structure, and sintering the de-bound build material structure in a second environment in the same chamber to form a build material object. In some such embodiments, the first environment is an oxidative environment having a temperature of greater than or equal to 220° C. and less than or equal to 450° C., as described above. The second environment within the chamber during sintering may have an elevated temperature, such as a temperature of greater than or equal to 750° C. and less than or equal to 1700° C., as described above. In some embodiments, the de-bound build material structure formed during the heating in the first environment is not removed from the chamber prior to the sintering step. For example, the build material-based composite structure may be heated in a first environment (e.g., an oxidative environment having a temperature of greater than or equal to 220° C. and less than or equal to 450° C.), and then, without removing the resulting de-bound build material structure, the temperature is increased (e.g., ramped) to a second environment having an elevated temperature for sintering (e.g., at a temperature of greater than or equal to 750° C. and less than or equal to 1700° C.).

The change in temperature between the first environment and the second environment may be achieved using any of a variety of techniques. In some embodiments, the chamber is configured to heat contents of the chamber to the temperature of a first environment and to also heat contents of the chamber to the temperature of a second environment by operating heating elements of the same type, or even by operating a single heating element. For example, in some embodiments the chamber is configured to heat contents of the chamber at a first temperature (in a first environment) by operating a heating element configured for convective heating, and the chamber is also configured to heat contents of the chamber at a second temperature (in a second environment) for sintering using the same convective heating element. As another example, the chamber may, in some instances, be configured to heat contents of the chamber in both in the first environment and the second environment using a radiative heating element. In some embodiments, the chamber comprises multiple heating elements, and is configured to heat contents of the chamber at a first temperature (in the first environment) using a first heating element and to heat contents of the chamber at a second temperature (in the second environment) using a second, different heating element. As one non-limiting example, the chamber may be configured to heat contents of the chamber in a first environment (e.g., an oxidative gaseous environment) using a first heating element configured for convective heat transfer, and the chamber may be configured to heat contents of the chamber in the second environment (e.g., a vacuum environment) for sintering using a second heating element configured for radiative heat transfer (e.g., an infrared lamp).

In some embodiments where the heating for de-binding and the sintering are performed in the same chamber, the second environment has the same type of gaseous environment as the first environment. For example, in some embodiments, the first environment is an oxidative environment (e.g., a gaseous environment containing oxygen, such as air), and the second environment used for sintering has the same oxidative environment. In some such embodiments, the build material-based composite structure (e.g., comprising platinum metal and/or a platinum alloy) is placed in the chamber at room temperature, and the temperature is first elevated to a de-binding temperature and then elevated to a sintering temperature without a change in the type of gaseous environment (e.g., oxidative) in the chamber. The change in temperature may occur in stages (e.g., with holds), or the change in temperature (e.g., from room temperature to the temperature of the first environment to the temperature of the second environment) may occur via a continuous temperature ramp, such that de-binding occurs during a portion of the temperature ramp. In some embodiments, the second environment used for sintering has a different type of gaseous environment than the first gaseous environment. For example, in some embodiments, the first environment is an oxidative environment (e.g., a gaseous environment containing oxygen, such as air), and the second environment used for sintering is an inert environment, or a vacuum environment, or a reductive environment (e.g., a gaseous environment containing hydrogen). In some instances where the second environment has a different type of gaseous environment than the first environment used de-binding, an intermediate environment is used between the first environment and the second environment. As one non-limiting example, the first environment used for de-binding may be an oxidative environment in a first temperature range (e.g., greater than or equal to 220° C. and less than or equal to 450° C.), and subsequently the chamber is changed to an intermediate environment having a reductive gaseous (or inert gaseous, or vacuum) environment but still in the first temperature range (e.g., greater than or equal to 220° C. and less than or equal to 450° C.). The de-bound build material structure is held at the intermediate environment for a period of time. The environment in the chamber is then changed to the second environment for sintering, the second environment having the same reductive gaseous (or inert gaseous, or vacuum) environment as the intermediate environment, but having an elevated temperature range (e.g., greater than or equal to 750° C. and less than or equal to 1700° C.).

The type of gaseous environment of the chamber may be changed using any of a variety of suitable techniques. For example, the chamber may be configured such that one or more gases (or gas mixtures) may be flowed into and/or through the headspace of the chamber. Exemplary configurations include chambers equipped with gas inlets and gas outlets, which may be operated (manually and/or automatically) to direct gas into or out of the chamber. In some embodiments, the gas inlet is fluidically connected to a gas mixture source and, optionally, configured with one or more pumps configured to flow the gas mixture into and/or through the chamber. In some embodiments in which the chamber is configured to heat a build material-based composite structure in a first environment and sinter a de-bound build material structure in a second environment having a different gaseous environment, the chamber is configured to be fluidically connected to two or more different gas mixture sources (e.g., with a gas inlet connected to two different gas tanks and valving for switching flow to the chamber between the different gas tanks, or two or more gas inlets connected to different pressurized gas tanks and valving for switching flow to the chamber between different gas inlets). As a specific example, the first environment may be air, and the second environment may be established by flowing a different gas mixture (e.g., a reductive gas such as forming gas) into and/or through the chamber (e.g., via a gas inlet optionally connected to a pump). In some cases, the chamber may be coupled to a reduced pressure source such as a vacuum pump, which may be operated to evacuate or otherwise remove gas from the interior of the chamber.

Another way to change the type of gaseous environment of the chamber may be to configure the chamber such that the gaseous environment can be evacuated via vacuum. For example, the chamber may comprise a headspace fluidically connected to a vacuum source and valving for exposing the headspace to the vacuum source when desired. The chamber may also be configured to flow gas mixtures into and through the headspace (e.g., via one or more gas inlets, gas outlets, valves and pumps connected to a gas mixture source). The chamber may be configured to back-fill the headspace with a gas mixture to establish a gaseous environment after a vacuum evacuation process. In some cases, the first environment is gaseous (e.g., air), the gas is evacuated from the chamber, and the chamber is subsequently back-filled with a different gas mixture (e.g., forming gas) to establish the second environment.

Formation of a build material object by sintering may comprise heating an environment in which a de-bound build material structure is positioned in for a variety of suitable amounts of time. In some embodiments, an environment in which a de-bound build material structure is positioned is heated for a time period of greater than or equal to 30 minutes, greater than or equal to 1 hour, greater than or equal to 2 hours, greater than or equal to 3 hours, greater than or equal to 6 hours, greater than or equal to 9 hours, greater than or equal to 12 hours, greater than or equal to 18 hours, greater than or equal to 1 day, or greater than or equal to 1.5 days. In some embodiments, an environment in which a de-bound build material structure is positioned is heated for a time period of less than or equal to 2 days, less than or equal to 1.5 days, less than or equal to 1 day, less than or equal to 18 hours, less than or equal to 12 hours, less than or equal to 9 hours, less than or equal to 6 hours, less than or equal to 3 hours, less than or equal to 2 hours, or less than or equal to 1 hour. Combinations of the above-referenced ranges are also possible (e.g., greater than or equal to 30 minutes and less than or equal to 2 days). Other ranges are also possible.

In some embodiments, heating a de-bound build material structure comprises heating the environment in which the de-bound build material structure is positioned to one temperature in one or more of the above-referenced ranges and holding the temperature of the environment thereat for an amount of time in one of the above-referenced ranges. As a non-limiting example, the entire sintering step may involve holding the temperature of the environment at 830° C. for 6 hours in certain cases. In some embodiments, heating a de-bound build material structure comprises heating an environment in which the de-bound build material is positioned to two or more temperatures in the above-referenced ranges sequentially and holding the temperature of the environment at each of the two or more temperatures. In such embodiments, the relevant environment may be held at each of the relevant temperatures for a period of time in one or more of the above-referenced ranges and/or may be heated such that the total time it is held at all of the relevant temperatures is in one or more of the above-referenced ranges. As a non-limiting example, the sintering step may involve holding the temperature at 700° C. for up to 3 hours, then holding the temperature at 820° C. for up to 3 hours, and then holding the temperature at 840° C. for up to 3 hours.

While some embodiments comprise sintering the de-bound build material structure a single time using the conditions described above, other embodiments comprise multiple such sintering steps. For example, an additive manufacturing method may comprise a first sintering step that forms an initial build material object, and then the initial build material object may undergo a second sintering step (e.g., under the same or different conditions as the first sintering step). It has been observed in the context of the present disclosure that a second sintering step (e.g., a second heating step during step 80) can lead to higher densities of finished build material products relative to instances where an otherwise identical process is performed but using just a single sintering step.

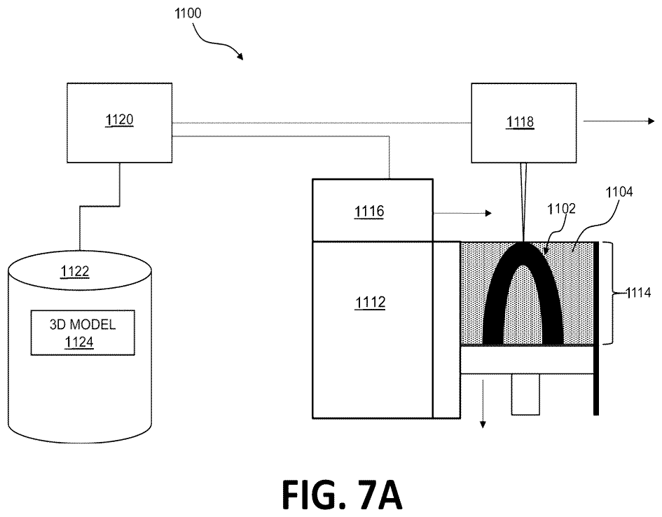

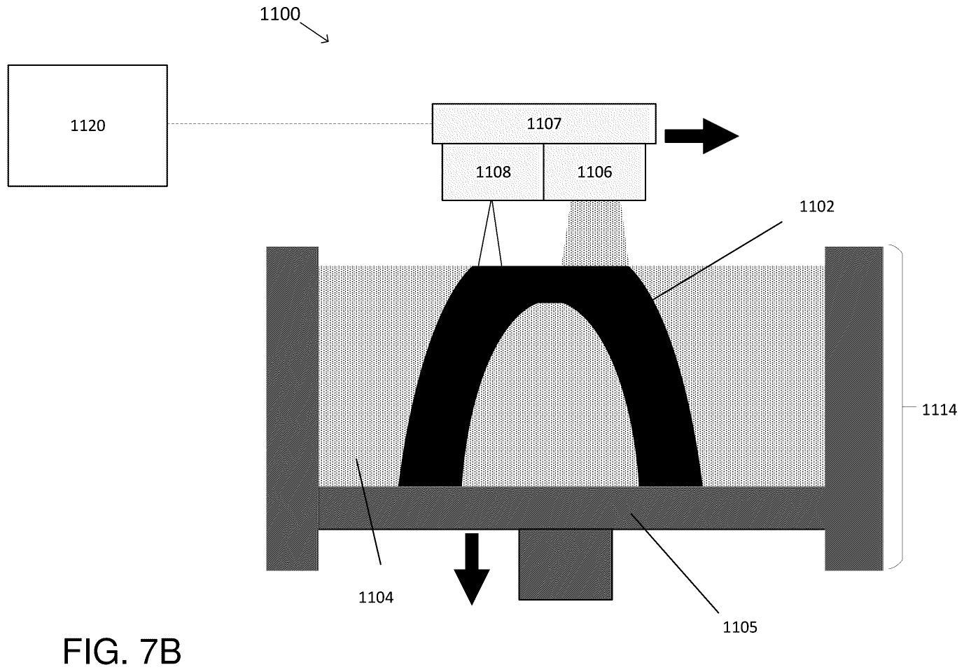

In some embodiments, one or more of the method steps described above may be performed in an additive manufacturing system. FIGS. 7A and 7B show two similar versions of an exemplary additive manufacturing system 1100. The various components of this additive manufacturing system and its operation are described below.

The additive manufacturing system 1100 shown in FIGS. 7A and 7B may be operated to form an article (part) 1102 from a build material powder 1104. The article 1102 may be a three-dimensional composition as described elsewhere herein. For instance, it may comprise a binder composition comprising the catalyst (and/or the precursor material) and a build material powder comprising a plurality of build material particles coated at least in part with the precursor material (and/or the catalyst) (e.g., as shown in FIGS. 3A-3C). As also described elsewhere herein, the three-dimensional composition 1102 can undergo subsequent steps to form a build material object. The additive manufacturing system shown in FIGS. 7A and 7B may be suitable for performing a binder jetting process to form a three-dimensional composition (e.g., by selectively joining portions of layers of build material powder with a binder composition in a sequential manner).

The additive manufacturing system 1100 shown in FIGS. 7A and 7B can include a powder deposition mechanism 1106 (e.g., shown in FIG. 7B) and a print head (e.g., shown as print head 1118 in FIG. 7A and print head 1108 in FIG. 7B), which may be coupled to and moved across the print area by a unit 1107 (e.g., as shown in FIG. 7B). The powder deposition mechanism 1106 may be operated to deposit a layer of build material powder by depositing powder 1104 onto the powder bed 1114.

In some embodiments, a powder deposition mechanism comprises a build material powder supply 1112, a build material powder bed 1114, and a spreader 1116 (e.g., as shown in FIG. 7A). When present, the spreader 1116 can be movable from the build material powder supply 1112 to the build material powder bed 1114 and along the build material powder bed 1114 to deposit a build material powder onto the build material powder bed 1114 and to deposit successive layers of the build material powder across the build material powder bed 1114. As described in more detail below, the additive manufacturing apparatus 1100 and/or the spreader 1116 therein may be configured to deposit layers of build material powder on the powder bed having any suitable geometry (e.g., layers of build material powder having a homogeneous, planar geometry; layers of build material powder having a morphology other than a homogeneous, planar geometry). Depending on the particular embodiment, the spreader 1116 may include, for example, a roller rotatable about an axis perpendicular to an axis of movement of the spreader 1116 across the powder bed 1114. The roller can be, for example, substantially cylindrical. In use, rotation of the roller about the axis perpendicular to the axis of movement of the spreader 1116 can deposit the build material powder from the build material powder supply 1112 to the build material powder bed 1114 and form a layer of the build material powder along the build material powder bed 1114. It should be appreciated, therefore, that a plurality of sequential layers of the material 1104 can be formed in the build material powder bed 1114 through repeated movement of the spreader 1116 across the build material powder bed 1114.

The print head 1108 (in FIG. 7B) and/or 1118 (in FIG. 7A) can be movable (e.g., in coordination with movement of the spreader 1116) across the build material powder bed 1114 and/or can be stationary (e.g., in embodiments in which the platform 1105 is movable). In some embodiments, the print head 1108 and/or 1118 includes one or more orifices through which a liquid (e.g., a binder composition) can be delivered from the print head 1118 to each layer of the build material powder along the build material powder bed 1114. In certain embodiments, the print head 1108 and/or 1118 can include one or more piezoelectric elements, and each piezoelectric element may be associated with a respective orifice and, in use, each piezoelectric element can be selectively actuated such that displacement of the piezoelectric element can expel liquid from the respective orifice. In some embodiments, the print head 1108 and/or 1118 may be arranged to expel a single liquid formulation from the one or more orifices. In other embodiments, the print head 1108 and/or 1118 may be arranged to expel a plurality of liquid formulations from the one or more orifices. For example, the print head 1108 and/or 1118 can expel a plurality of liquids (e.g., a plurality of solvents), a plurality of components of a binder composition, or both from the one or more orifices. Moreover, in some instances, expelling or otherwise delivering a liquid from the print head may include emitting an aerosolized liquid (i.e., an aerosol spray) from a nozzle of the print head.

In general, the print head 1108 in FIG. 7B and/or 1118 in FIG. 7A may be controlled to deliver liquid such as a binder composition comprising to the build material powder bed 1114 in predetermined two-dimensional patterns, with each pattern corresponding to a respective layer of the three-dimensional composition 1102. In this manner, the delivery of the binder composition may be a printing operation in which the build material powder in each respective layer of the three-dimensional composition is selectively joined along the predetermined two-dimensional layers. After each layer of the three-dimensional composition is formed as described above, the platform 1105 may be moved down and a new layer of build material powder deposited, binder composition again applied to the new build material powder, etc. until the object has been formed.

In some embodiments, the print head 1108 (in FIG. 7B) and/or 1118 (in FIG. 7A) can extend axially along substantially an entire dimension of the build material powder bed 1114 in a direction perpendicular to a direction of movement of the print head 1108 and/or 1118 across the build material powder bed 1114. For example, in such embodiments, the print head 1118 can define a plurality of orifices arranged along the axial extent of the print head 1108 and/or 1118, and liquid can be selectively jetted from these orifices along the axial extent to form a predetermined two-dimensional pattern of liquid along the build material powder bed 1114 as the print head 1108 and/or 1118 moves across the build material powder bed 1114. In some embodiments, the print head 1108 and/or 1118 may extend only partially across the build material powder bed 1114, and the print head 1108 and/or 1118 may be movable in two dimensions relative to a plane defined by the powder bed 1114 to deliver a predetermined two-dimensional pattern of a liquid along the powder bed 1114.

The additive manufacturing system 1100 generally further includes a controller 1120 in electrical communication with one or more other system components. For instance, in FIG. 7A, a controller 1120 is in electrical communication with the build material powder supply 1112, the build material powder bed 1114, the spreader 1116, and the print head 1118. In FIG. 7B, the controller 1120 is in electrical communication with the unit 1107, the powder deposition mechanism 1106, and the print head 1108. Also in FIG. 7B, the controller 1120 may be configured to control the motion of the unit 1107, the material deposition mechanism 1106, and the print head 1108 as described above.

A non-transitory, computer readable storage medium 1122 may be in communication with the controller 1120 and have stored thereon a three-dimensional model 1124 and instructions for carrying out any one or more of the methods described herein. Alternatively, the non-transitory, computer readable storage medium may comprise previously prepared instructions. With reference to FIG. 7B, such instructions, when executed by the controller 1120, may operate the platform 1105, the unit 1107, the material deposition mechanism 1106, and the print head 1108 to fabricate one or more three-dimensional compositions. For example, one or more processors of the controller 1120 can execute instructions to move the unit 1107 forwards and backwards along an x-axis direction across the surface of the powder bed 1114. One or more processors of the controller 1120 also may control the material deposition mechanism 1106 to deposit build material onto the build material powder bed 1114.

With reference to FIG. 7A, one or more processors of the controller 1120 can execute instructions to control movement of one or more of the build material powder supply 1112 and the build material powder bed 1114 relative to one another as the three-dimensional composition 1102 is being formed. For example, one or more processors of the controller 1120 can execute instructions to move the build material powder supply 1112 in a z-axis direction toward the spreader 1116 to direct the build material powder 1104 toward the spreader 1116 as each layer of the three-dimensional composition 102 is formed and to move the build material powder bed 1114 in a z-axis direction away from the spreader 1116 to accept each new layer of the build material powder along the top of the build material powder bed 1114 as the spreader 1116 moves across the build material powder bed 1114. One or more processors of the controller 1120 also may control movement of the spreader 1116 from the build material powder supply 1112 to the build material powder bed 1114 to move successive layers of the build material powder across the build material powder bed 1114.

In some embodiments, one or more processors of the controller 1120 can control movement of the print head 1108 (in FIG. 7B) and/or 1118 (in FIG. 7A) to deposit liquid such as a binder composition onto selected regions of the build material powder bed 1114 to deliver a respective predetermined two-dimensional pattern of the liquid to each new layer of the build material powder 1104 along the top of the build material powder bed 1114. In general, as a plurality of sequential layers of the build material powder 1104 are introduced to the build material powder bed 1114 and the predetermined two-dimensional patterns of the liquid are delivered to each respective layer of the plurality of sequential layers of the build material powder 1104, the three-dimensional composition 1102 is formed according to the three-dimensional model (e.g., a model stored in a non-transitory, computer readable storage medium coupled to, or otherwise accessible by, the controller 1120, such as three-dimensional model 1124 stored in the non-transitory, computer readable storage medium 1122). In certain embodiments, the controller 1120 may retrieve the three-dimensional model (e.g., three-dimensional model 1124) in response to user input, and generate machine-ready instructions for execution by the additive manufacturing system 1100 to fabricate the three-dimensional object 1102.

As described above, it will be appreciated that the illustrative additive manufacturing system 1100 is provided as one example of a suitable additive manufacturing system and is not intended to be limiting with respect to the techniques described herein for controlling the flow behavior of a build material powder. For instance, it will be appreciated that the techniques may be applied within an additive manufacturing apparatus that utilizes only a roller as a material deposition mechanism and does not include material deposition mechanism 1106.

According to some embodiments, the techniques described herein for controlling the flow behavior of a build material powder may be employed to control properties of a build material powder for a binder jet additive manufacturing system. Such a system may comprise additive manufacturing system 1100 in addition to one or more other apparatus for producing a completed part (e.g., a build material object as described herein). Such apparatus may include, for example, an oven for debinding and/or sintering a three-dimensional composition fabricated by the additive manufacturing system 1100 (or for de-binding and/or sintering such a three-dimensional composition subsequent to applying other post-processing steps upon the three-dimensional composition).

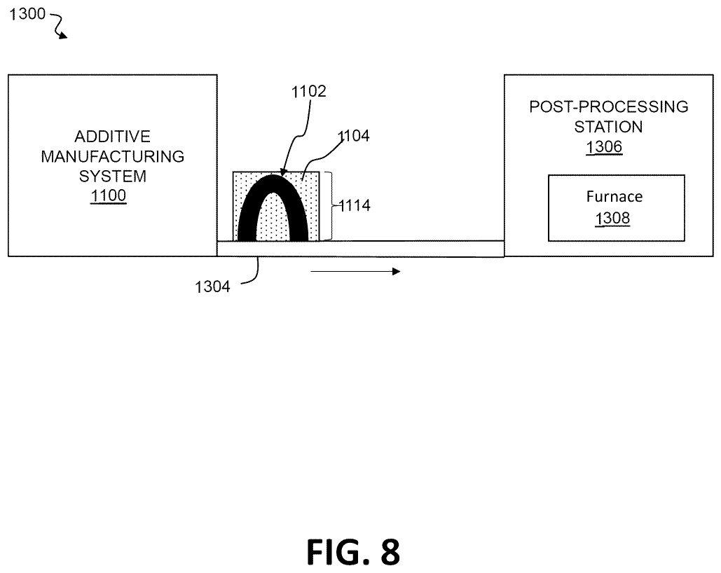

Referring now to FIG. 8, an additive manufacturing plant 1300 can include the additive manufacturing system 1100, a conveyor 1304, and a post-processing station 1306. The build material powder bed 1114 containing the three-dimensional composition 1102 can be moved along the conveyor 1304 and into the post-processing station 1306. The conveyor 1304 can be, for example, a belt conveyor movable in a direction from the additive manufacturing system 1100 toward the post-processing station. Additionally, or alternatively, the conveyor 1304 can include a cart on which the powder bed 1114 is mounted and, in certain instances, the powder bed 1114 can be moved from the additive manufacturing system 1100 to the post-processing station 1306 through movement of the cart (e.g., through the use of actuators to move the cart along rails or by an operator pushing the cart).

In the post-processing station 1306 shown in FIG. 8, the three-dimensional composition 1102 can be heated in the build material powder bed 1114 to remove at least some of the liquid of the binder composition in the three-dimensional composition and to form a build material-based composite structure (e.g., a self-supporting build material-based composite structure) within the build material powder bed. The build material-based composite structure can be removed from the build material powder bed 1114. According to some aspects, the binder compositions described herein may aid in attaining a desired mechanical strength characteristic of the build material-based composite structure, thereby allowing for improved ability to handle the build material-based composite structure and improved consistency in build material objects formed from such build material-based composite structures. The build material powder 1104 remaining in the build material powder bed 1114 upon removal of the build material-based composite structure can be, for example, recycled for use in subsequent fabrication of additional parts. Additionally, or alternatively, in the post-processing station 1306, the build material-based composite structure can be cleaned (e.g., through the use of pressurized air) of excess amounts of the build material powder 1104.

In systems employing a binder jetting process, a build material-based composite structure can undergo one or more de-binding processes (e.g., step 70 of FIGS. 1A-1B) in the post-processing station 1306 to remove all or a portion of a polymer of the binder composition from the build material-based composite structure 1102. One example of a suitable de-binding process is a thermal de-binding process (e.g., heating as described elsewhere herein, particularly in the context of noble metals and/or copper).

The post-processing station 1306 shown in FIG. 8 can include furnace 1308. The build material-based composite structure can undergo de-binding in furnace 1308. In some embodiments, the de-bound build material structure can undergo sintering (e.g., step 80 of FIG. 1B) in furnace 1308 such that the build material particles of the powder 1106 melt (e.g., to an extent not overall undesirable) and combine with one another to form a build material object.

As described above, in some embodiments, a binder composition comprising a catalyst for a metathesis chain-growth polymerization reaction (and/or a precursor material comprising a monomer and/or polymer comprising an unsaturated carbon-carbon bond) (and/or one or more components thereof) is configured to form one or more of the articles described herein (e.g., a three-dimensional composition) in combination with a build material powder coated at least in part with the precursor material (and/or the catalyst), as described herein. In some embodiments, one or more of the articles described herein (e.g., a de-bound build material composition or a build material object) may be formed from a binder composition described herein. Such articles may comprise the binder composition, may comprise some components of the binder composition but lack other components of the binder composition (e.g., may comprise a catalyst, monomer, polymer, and/or activator present in the binder composition but lack a solvent present in the binder composition), or may not include any components of the binder composition. In some embodiments, an article described herein comprises a reaction product of a binder composition (e.g., a polymer formed from or catalyzed by a portion of the binder composition; a polymer present in the binder composition that has been cross-linked, such as by a cross-linking agent present in the binder composition; a thermal decomposition product of a component of the binder composition, such as char).

As also described above, some binder compositions described herein may have one or more physical properties that enhances their suitability for use in one or more of the methods described herein, such as one or more of the methods for additive manufacturing described herein, and/or in one or more of the articles described herein, such as a three-dimensional object, a build material-based composite structure, a de-bound build material structure, and/or a build material object. Further details regarding some such physical properties is provided below.

In some embodiments, a binder composition described herein may have an advantageous viscosity. Without wishing to be bound by any particular theory, it is believed that the viscosity of the binder composition may affect its ability to be printed by a particular print head. For instance, some print heads may be designed to print binder compositions having a certain range of viscosities and may be unable to print compositions having viscosities outside of this range in a manner that is reliable and/or desirable. By way of example, binder compositions having viscosities above the range for which the print head is configured may not flow or may not flow appreciably at the pressures provided by the print head. As another example, binder compositions having viscosities below the range for which the print head is configured may flow in undesirable manners at the pressures provided by the print head (e.g., flow in a manner that produces droplets that are coalesced, take the form a mist, and/or misdirected), resulting in poor control over the deposition of the binder composition from the print head.

In some embodiments, a binder composition has a viscosity at a printing temperature of greater than or equal to 0.55 cP, greater than or equal to 1 cP, greater than or equal to 1.5 cP, greater than or equal to 2 cP, greater than or equal to 2.5 cP, greater than or equal to 3 cP, greater than or equal to 3.5 cP, greater than or equal to 4 cP, greater than or equal to 5 cP, greater than or equal to 6 cP, greater than or equal to 7 cP, greater than or equal to 8 cP, greater than or equal to 10 cP, greater than or equal to 12.5 cP, greater than or equal to 15 cP, greater than or equal to 17.5 cP, greater than or equal to 20 cP, greater than or equal to 22.5 cP, greater than or equal to 25 cP, or greater than or equal to 27.5 cP. In some embodiments, a binder composition has a viscosity at a printing temperature of less than or equal to 30 cP, less than or equal to 27.5 cP, less than or equal to 25 cP, less than or equal to 22.5 cP, less than or equal to 20 cP, less than or equal to 17.5 cP, less than or equal to 15 cP, less than or equal to 12.5 cP, less than or equal to 10 cP, less than or equal to 8 cP, less than or equal to 7 cP, less than or equal to 6 cP, less than or equal to 5 cP, less than or equal to 4 cP, less than or equal to 3.5 cP, less than or equal to 3 cP, less than or equal to 2.5 cP, less than or equal to 2 cP, less than or equal to 1.5 cP, or less than or equal to 1 cP. Combinations of the above-referenced ranges are also possible (e.g., greater than or equal to 0.55 cP and less than or equal to 30 cP, greater than or equal to 1 cP and less than or equal to 10 cP, greater than or equal to 3 cP and less than or equal to 30 cP, or greater than or equal to 3 cP and less than or equal to 10 cP). Other ranges are also possible. The viscosity of the binder composition may be determined by use of a cone and plate rheometer operated at a shear rate of 300 s⁻¹.

The viscosities described above may be desirable for use with particular print heads of interest (e.g., piezoelectric print heads, thermal print heads, print heads suitable for ink jet printing). By way of example, in some embodiments, it may be desirable for a binder composition configured to be deposited thermally (e.g., by a thermal print head) to have a viscosity of greater than or equal to 1 cP and less than or equal to 10 cP at the printing temperature. As another example, in some embodiments, it may be desirable for a binder composition configured to be deposited piezoelectrically (e.g., by a piezoelectric print head) to have a viscosity of greater than or equal to 3 cP and less than or equal to 30 cP at the printing temperature.

The printing temperature may be a temperature at which the binder composition is ejected from a print head (e.g., by an additive manufacturing process, by a binder jetting process). In some embodiments, the printing temperature is greater than or equal to 20° C., greater than or equal to 25° C., greater than or equal to 30° C., greater than or equal to 35° C., or greater than or equal to 40° C. In some embodiments, the printing temperature is less than or equal to 45° C., less than or equal to 40° C., less than or equal to 35° C., less than or equal to 30° C., or less than or equal to 20° C. Combinations of the above-referenced ranges are also possible (e.g., greater than or equal to 20° C. and less than or equal to 40° C.). Other ranges are also possible.

As described above, some binder compositions have pHs that are non-corrosive to one or more articles with which the binder composition is configured to contact during formation of a build material-based composite structure. As also described above, these components may include portions of a printer, such as a print head, and/or components to be incorporated into a build material-based composite structure, such as a build material powder. In some embodiments, a binder composition that is a weak acid or that is a base may be less corrosive to such components than a binder composition that is a strong acid. Some binder compositions that are weak acids and/or bases may be non-corrosive to such components. For binder compositions configured to be employed with a build material powder particularly susceptible to corrosion, such as a steel powder, suitable values of pH for the binder composition may be higher than for those configured to be employed with a plurality of particles less susceptible to corrosion.

In some embodiments, a binder composition has a pH of greater than or equal to 4, greater than or equal to 4.5, greater than or equal to 5, greater than or equal to 5.5, greater than or equal to 6, greater than or equal to 6.5, greater than or equal to 7, greater than or equal to 7.5, greater than or equal to 8, greater than or equal to 8.5, greater than or equal to 9 greater than or equal to 9.5, greater than or equal to 10, or greater than or equal to 10.5. In some embodiments, a binder composition has a pH of less than or equal to 11, less than or equal to 10.5, less than or equal to 10, less than or equal to 9.5, less than or equal to 9, less than or equal to 8.5, less than or equal to 8, less than or equal to 7.5, less than or equal to 7, less than or equal to 6.5, less than or equal to 6, less than or equal to 5.5, or less than or equal to 5. Combinations of the above-referenced ranges are also possible (e.g., greater than or equal to 4 and less than or equal to 11, greater than or equal to 5 and less than or equal to 8, greater than or equal to 7 and less than or equal to 11, or greater than or equal to 7 and less than or equal to 9). Other ranges are also possible. The pH of a binder composition may be measured with a pH meter.

In some embodiments, the pH of the binder composition may be selected to be compatible with the particular type of build material powder it will be used in combination with. For instance, it may be desirable for binder compositions suitable for use with ferrous alloys having low chromium contents (e.g., below 2 wt %, such as 4140 low alloy steel) to have a weakly basic pH (e.g., greater than or equal to 7 and less than or equal to 11, or greater than or equal to 7 and less than or equal to 9). As another example, it may be desirable for binder compositions suitable for use with steels having appreciable chromium contents (e.g., in excess of 2 wt %, such as stainless steels and some non-stainless steels) to have weakly acidic or weakly basic values of pH (e.g., greater than or equal to 4 and less than or equal to 11, or greater than or equal to 5 and less than or equal to 8).

The binder compositions described herein may have a variety of suitable surface tensions. For instance, in some embodiments, a binder composition has a surface tension of greater than or equal to 18 dynes/cm, greater than or equal to 20 dynes/cm, greater than or equal to 22.5 dynes/cm, greater than or equal to 25 dynes/cm, greater than or equal to 28 dynes/cm, greater than or equal to 30 dynes/cm, greater than or equal to 32.5 dynes/cm, greater than or equal to 35 dynes/cm, greater than or equal to 40 dynes/cm, greater than or equal to 45 dynes/cm, greater than or equal to 50 dynes/cm, greater than or equal to 55 dynes/cm, greater than or equal to 60 dynes/cm, or greater than or equal to 65 dynes/cm. In some embodiments, a binder composition has a surface tension of less than or equal to 70 dynes/cm, less than or equal to 65 dynes/cm, less than or equal to 60 dynes/cm, less than or equal to 55 dynes/cm, less than or equal to 50 dynes/cm, less than or equal to 45 dynes/cm, less than or equal to 40 dynes/cm, less than or equal to 35 dynes/cm, less than or equal to 32.5 dynes/cm, less than or equal to 30 dynes/cm, less than or equal to 28 dynes/cm, less than or equal to 25 dynes/cm, less than or equal to 22.5 dynes/cm, or less than or equal to 20 dynes/cm. Combinations of the above-referenced ranges are also possible (e.g., greater than or equal to 18 dynes/cm and less than or equal to 70 dynes/cm). Other ranges are also possible. The surface tension of a binder composition may be measured in accordance with ASTM D1331-14.

The binder compositions described herein may advantageously produce three-dimensional compositions and/or build material-based composite structures with acceptable mechanical strength when applied to any of a wide variety of build material powders. According to some embodiments, the strength of three-dimensional compositions and/or build material-based composite structures may be measured in a variety of ways, including by measuring the transverse rupture strength (also sometimes called flexural strength), bending strength, yield strength, compressive strength, tensile strength, fatigue strength, or impact strength. Where three-dimensional compositions and/or build material-based composite structures are referred to herein as having a higher “strength” than three-dimensional compositions and/or build material-based composite structures produced using conventional binder compositions, this may refer to any of these measures of strength (or other suitable measures).

As described above, in some embodiments, a binder composition as a whole may comprise a combination of advantageous components. Further details regarding such components are provided below.

### Precursor Material

As described above, a precursor material may coat at least some of the build material powder and/or may be part of the binder composition.

In some embodiments, the precursor material comprises a monomer and/or a polymer. The monomer and/or polymer may be capable of participating in a metathesis chain-growth polymerization reaction under at least some conditions (e.g., in the presence of suitable reagents and/or catalysts). In some embodiments, the monomer and/or polymer comprises an unsaturated carbon-carbon bond. The monomer and/or the polymer may have any of a number of unsaturated carbon-carbon bonds (e.g., one or more, two or more, or more unsaturated carbon-carbon bonds). Examples of unsaturated carbon-carbon bonds include carbon-carbon double bonds and carbon-carbon-triple bonds. Metathesis chain-growth polymerization reactions include olefin metathesis chain-growth polymerization reactions. Examples of olefin metathesis chain-growth polymerization reactions include, but are not limited to ring-opening metathesis polymerization (ROMP) and acyclic diene metathesis (ADMET) polycondensation.

In certain embodiments, a combination of materials may be combined to cause or accelerate a metathesis chain-growth polymerization reaction (e.g., ROMP reaction, an ADMET reaction). According to certain embodiments, the metathesis chain-growth polymerization reaction (e.g., ROMP reaction, an ADMET reaction) involves an olefinic material and a catalyst. The olefinic material (e.g., the olefinic monomer and/or polymer) is acted upon by the catalyst, and polymerizes to increase in molecular weight through the reaction of several of the individual olefinic materials (e.g., individual monomers and/or polymers). Suitable olefinic materials generally exhibit at least one unsaturated carbon-carbon bond (e.g., a double bond). For example, the monomer and/or polymer may comprise a cyclic group comprising a single unsaturated carbon-carbon bond (e.g., for a ROMP reaction). The inventors have realized and appreciated that in some instances use of cyclic enes in the precursor material can provide for reduced viscosity, which may be desirable in some embodiments. In some embodiments, the olefinic material (e.g., the monomer and/or polymer) is a diene. For example, the monomer and/or polymer may comprise an acyclic group comprising two unsaturated carbon-carbon bonds (e.g., for an ADMET reaction). Further, and to not be bound by any particular theory, olefinic materials that possess some degree of ring strain tend to be favored in at least some embodiments for their tendency for reaction relative to similar olefinic materials with lesser degrees of ring strain. For example, in certain embodiments, 3, 4, and 5 membered rings with at least one unsaturated bond (including dienes) may be favored over a 6 membered ring with a similar degree of saturation (or unsaturation) as, and to not be bound by any particular theory, bond angles formed by 6 membered rings lead to lesser degrees of internal strain energy and reaction of 6 membered rings is less thermodynamically favored when compared to 3, 4, and 5 membered rings; similarly, 7, 8, and 9 membered rings may also be favored as compared to 6 member rings. In some embodiments, the monomer and/or polymer comprises a multicyclic ring. In certain embodiments, bicyclic and tricyclic rings may be utilized. For example, the monomer and/or polymer may comprise a bicyclic ring (e.g., dicyclopentadiene). The inventors have realized and appreciated that in some instances the use of cyclic enes can lead to linear polymers, the use of bicyclic enes can lead to linear polymers with bulky side groups, and the use of bicyclic dienes with an ene in each cyclic group can lead to crosslinked polymers following the metathesis chain-growth polymerization reaction.

According to some embodiments, a binder for additive fabrication may comprise one or more cyclic olefins. The cyclic olefin(s) may undergo the ROMP reaction with one or more catalysts that are mixed with a powder for additive fabrication. The binder may be deposited onto selected regions of the powder, thereby causing those regions to form a polymer as a result of the ROMP reaction. In some embodiments, the binder may comprise dicyclopentadiene as a monomer.

In certain embodiments, monomer of the precursor material comprises a monocyclic or bicyclic monomer. Examples of monocyclic monomers which may be suitable for metathesis chain-growth polymerization reactions (e.g., ROMP) include, but are not limited to, norbornene, cyclopentene, cycloheptene, cyclooctene, 1,5-cyclooctadiene, cyclopentadiene, 3a,4,7,7a-tetrahydroindene, and benzonorbornadiene, and others. A selection of such monomers is shown as follows, including dicyclopentadiene (structure I), hydrodydicyclopentadiene (structure III), and 1-methyldicyclopentadiene (structure VI).

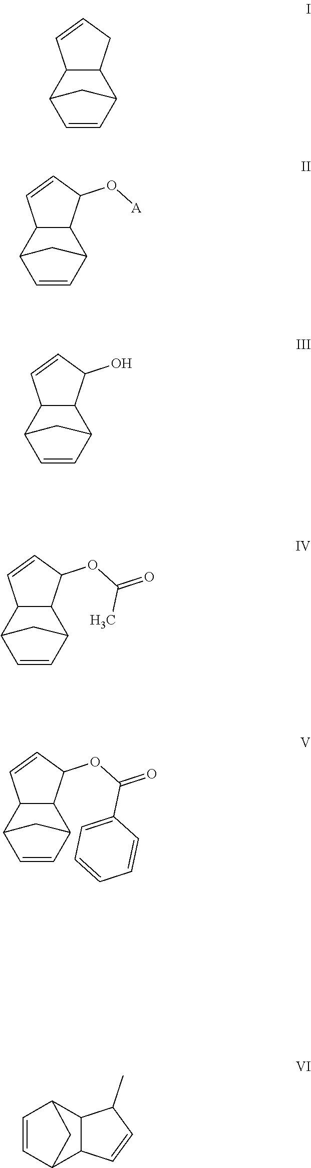

Note that while the structures II, IV, and V may be named following IUPAC nomenclature, it is believed that they do not have a simpler/common name in the chemical literature. Further, and with reference to structure II above, other variations may occur by substitution of various functional groups at position “A”, for example: when A is an alkyl group such as methyl (CH₃), propyl (C₃H₇), or octyl group (C₈H₁₇). According to certain embodiments, such functional groups may impart functionality including compatibility with solvents or tuned rates of reaction relative to other monomers and/or polymers present in a blend of materials. In certain embodiments, monomers containing additional functional groups (e.g., methyl, cyano, alcohol, carboxylate, primary amines, secondary amines, tertiary amines, halides, and the like) and atoms (e.g., oxygen, nitrogen, phosphorous, and the like) may be included on the olefinic monomer to impart additional functionality. The choice of functional group on the monomer generally leads to a corresponding choice in catalyst (as certain functional groups are incompatible with certain olefin metathesis catalysts)). The additional functionality relative to non-substituted monomers may include, in certain embodiments, targeted solubility (to be made more or less soluble) in a particular solvent, different debinding characteristics (to tailor the amount of oxygen and/or carbon remaining following a debind process, for example), and tailored adhesion (including improved adhesion) of the monomer (and/or polymer therefrom produced) to the surface of the build material powder relative to a similar monomer absent the functional groups, among other characteristics. Regarding the selection among various monomers to tune the adhesion of the monomer and resulting polymer to achieve improved adhesion to the surface of the build material powder, it will be appreciated that, in certain embodiments, and to not be bound by any particular theory, adhesive forces between materials may be enhanced on the surface of build material powders when some amount of electron density is present in the monomer or polymer that is capable of being polarized by surface groups present on the surface of the build material. Materials that are saturated (e.g., not exhibiting a double or triple bond) and absent non-carbon containing functional groups tend not to possess regions of electron density that are polarizable and amenable to adhesive interactions. In contrast, unsaturated regions and functional groups with electronegativities different than the carbon atoms forming the majority of the olefinic materials may produce variations in electron density that are relatively amenable to polarization and may exhibit increased adhesive interactions. Various monomers exhibiting a variety of functional groups that may encourage such adhesive interactions, according to certain embodiments, include but are not limited to: bicyclo[2.2.1]hept-5-ene-2,3-dicarboxylic anhydride, 5-norbornene-2,3-dicarboxylic acid, N-methyl-7-oxanorbornene-5,6-dicarboximide, and hydrodicyclopentadiene. Further, in certain embodiments, functional groups with relatively long hydrocarbon chains (e.g., chains of greater than or equal to 8 carbons, greater than or equal to 10 carbons, greater than or equal to 12 carbons, or greater) may rely upon a large number of hydrogen bonding or entropic adhesive interactions (as would be the case when the functional group A structure II above is a relatively long hydrocarbon chain) may be used.

In some embodiments, the precursor material comprises a polymer (e.g., for a metathesis chain-growth polymerization reaction such as a ROMP reaction). Examples of polymers which may be suitable include, but are not limited to, polynorbornene, polydicyclopentadiene, polycyclooctene, polycyclopentene, polycyclooctene. In general, the monomers previously described, listed, and included in the teachings here may be crosslinked or otherwise combine or polymerized to form polymers that may also be used. By way of non-limiting example, structure III above, hydrodicyclopentadiene, may be polymerized for form poly(hydrodicyclopentadiene). Polymeric materials may be formed from the polymerization of monomeric materials, where the polymerization is carried out to an extent normally considered small for a polymer, as measured by a degree of polymerization corresponding to a number of monomer (or repeat) units from which the polymer is formed. For example, and according to some embodiments, polymers exhibiting greater than or equal to 2 monomers, greater than or equal to 5 monomers, greater than or equal to 25 monomers, and/or up to 50 monomers, up to 100 monomers, or more (e.g., between 2 and 10 monomers, 5 to 50, or 25 to 100 monomers) may be useful. Further, and according to some embodiments, higher degrees of polymerization may be utilized and may be in the range of greater than or equal to 100, greater than or equal to 1,000, greater than or equal to 10,000, or more (e.g., from 100 to 1,000, 1,000 to 10,000, or above 10,000) monomeric units. The degree of polymerization may be chosen by such characteristics as: (1) solubility of the polymer within a mixture of monomers and/or a particular solvent or solvent mixture, (2) a viscosity of a mixture comprising the polymer, or any other physicochemical characteristic affected, controlled, or dependent upon the degree of polymerization of the polymer, according to some embodiments. In some embodiments, the polymer is linear or exhibits substantially no branching.

According to certain embodiments, more than one type of olefinic material may be used. For example, the precursor material (e.g., coated on the build material powder and/or present in the binder composition) may comprise a first monomer and/or first polymer, and the precursor material may further comprise a second monomer and/or a second polymer comprising an unsaturated carbon-carbon bond, where the first monomer and/or first polymer is different than the second monomer and/or second polymer. For example, the precursor material may comprise monomers of both dicyclopentadiene and cyclooctene. In some embodiments, the precursor material comprises same type of olefinic material but with a portion of that olefinic material being in a polymeric form and a portion of the olefinic material being in monomeric form (e.g., a mixture of dicyclopentadiene and poly(dicyclopentadiene).

In some embodiments a mixtures of monomers having unsaturated carbon-carbon-bonds may be used to achieve specific mechanical properties in the resulting polymeric material. For example, dicyclopentadiene (DCPD) often forms a rigid plastic with a high glass transition (often >100° C.) and low elongation (˜5% to 20% strain at break). 1,5-cyclooctadiene (COD), on the other hand, forms a polymer with a low glass transition (˜−100° C.) elastomer and high elongation (before strain hardening). Mixtures of these two monomers (DCPD and COD) can be used to form materials with properties ranging from soft elastomers to rigid plastics (and many points in between) by changing the ratio of monomers (see, e.g., Dean, L. et al ACS Macro Lett. 2020, 9, 819-824). Similar strategies can be utilized with any number of olefinic monomers in various combinations to achieve a range of properties which may include: controlled mechanical properties, improved reaction kinetics and increased adhesion to surfaces (such as build material).

Monomers may also be mixed with polymers to enhance the properties of the resultant combination, according to some embodiments. Polymers often possess improved elongation, impact strength and surface adhesion. Polymers can be made from olefinic monomers (described above) and can also be formed from any number of organic materials possessing unsaturated alkenes (e.g., alpha, omega-telechelic alkenes, and norbornenes). Polymers may include but are not limited to, polyesters, polyurethanes, polystyrenes, polyacrylics, and polyolefins. In some embodiments, polymers and/or monomers may be included as components in coating materials and/or as additives in binder compositions.

The monomer and/or polymer comprising the unsaturated carbon-carbon bond may be present in the precursor material in a relatively large amount (e.g., the precursor material in the coating and/or in the binder composition). In some embodiments, the monomer and/or polymer comprising the unsaturated carbon-carbon bond is present in the precursor material in an amount of greater than or equal to 80 wt %, greater than or equal to 90 wt %, greater than or equal to 95 wt %, greater than or equal to 98 wt %, greater than or equal to 99 wt %, greater than or equal to 99.9%, or greater (e.g., 100 wt %) by weight of the precursor material.

The precursor material may be present in the coating on the build material powder and/or in the binder composition in a relatively large amount. In some embodiments, the precursor material is present in the coating on the build material powder and/or in the binder composition in an amount of greater than or equal to 10 wt %, greater than or equal to 25 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal to 95 wt %, greater than or equal to 98 wt %, greater than or equal to 99 wt %, greater than or equal to 99.9%, or greater (e.g., 100 wt %) by weight of the coating and/or the binder composition.

As noted above, a catalyst may be present in the binder composition and/or as a coating on at least some of the build material powder. The catalyst may be one that catalyzes a metathesis chain-growth polymerization reaction (e.g., an olefin metathesis polymerization reaction such as ROMP or ADMET). Examples of catalysts suitable for such reactions (e.g., olefin metathesis polymerization such as ROMP) include, but are not limited to, metal center catalysts such as transition metal catalysts. Various classes of catalysts are available and may be utilized in ROMP reactions. Certain catalysts utilize metal centers (e.g., as part of a metal-containing coordination complex), where the metals include: titanium, zirconium, hafnium, tantalum, niobium, molybdenum, tungsten, rhenium, ruthenium, osmium, thallium, and iridium. For example, the catalyst may comprise a ruthenium metal center. Various classes of catalysts exist in both the literature and in commercial catalogues from chemical manufacturers. These classes of catalysts are often, but not always, distinguished by the type of metal center present in the catalyst. Of particular note are the so-called “Grubbs Catalysts” and “Schrock Catalysts”. Grubbs catalysts typically utilize a ruthenium metal center, whereas Schrock catalysts utilize tungsten or molybdenum metal centers. Catalysts of significant commercial interest include, but are not limited to: 1^{st} Generation Grubbs Catalyst (phosphine ligands; examples include CAS #172222-30-9), 2^{nd} Generation Grubbs Catalyst (Nitrogen-heterocyclic carbene (NCH) ligands; examples include CAS #246047-72-3), 3^{rd} Generation Grubbs Catalyst (3-bromopyridine ligands; examples include CAS #900169-53-1), Hoveyda-Grubbs Catalyst (chelated styryl ether ligand; examples include CAS #203714-71-0) and derivatives thereof. In some embodiments, the catalyst comprises an alkylidene group.

The rate of catalytic activity for the above-mentioned reactions is known to vary as a function of reaction environment (solvent effect). Catalytic activity can be controlled, accelerated or retarded, by the choice of appropriate solvent.

In certain embodiments, the amount of catalyst required, relative to an amount of participating monomer and/or polymer, to facilitate a metathesis chain-growth polymerization reaction varies depending upon the temperature of the various components participating in the reaction, as well as other environmental variables (including physical and chemical environmental variables), such as the presence of water, solvent selection, salts, and the like. According to certain embodiments, the amount and type of catalyst used depends upon the amount of ring strain within the participating monomers and/or polymers. Without wishing to be bound by any particular theory, the amount of ring strain may be greater in olefinic molecules exhibiting bi- and tricyclic rings (such as DCPD or norbornene, for example) as compared to olefinic molecules exhibiting one ring (such as cyclooctene, 1,5,-cyclooctadiene, or cyclopentene, for example).

Catalysts may be provided on supporting materials or provided as a component to a liquid or liquid-like solution, according to some embodiments. Supporting materials may be a finely divided solid filler material such as alumina, silica, or other metal oxide (such as iron oxide, for example), according to some embodiments. The characteristic size (such as a diameter) of the finely divided filler material may be less than 10 nanometers, e.g., in the range from 5 to 100 nanometers, or greater than 100 nanometers, according to certain embodiments. In certain embodiments, iron oxide or silica supporting a catalysts exhibit particularly desirable activity, as the silica may act as a flow aid to decreased cohesion within a build material powder and additionally, may incorporate well with build material powders where silica or iron are tolerated after thermal processing, according to some embodiments. In certain embodiments, a fumed silica may be utilized as a finely divided solid filler material. In certain embodiments iron oxide nanoparticles may be utilized as a finely divided filler material. In still further embodiments, the alumina, silica, iron, or other metal oxide are additionally treated with a hydrophobic, a hydrophilic, or a mixture of hydrophobic and hydrophilic surface modifiers to affect or tune the wettability of the surface of the finely divided filler material as the finely divided filler material interacts with a liquid such as binder composition. In certain embodiments, the surface modifier may be an organosilane coupling agent or a surfactant.

Some catalyst activity is significantly impacted by the presence of water. Variations on Grubbs catalyst (different ligand environments) may respond differently to the presence of water present in the reaction medium. For example, in one case a drop of 60% in yield was reported form the presence of 100 ppm water (ACS Catal. 2021, 11, 893-899). The selection of the proper catalyst will need to be matched to the proper environment to achieve desirable yield from the polymerization reaction. In some embodiments, the catalyst is chosen as a function of the ambient moisture present in the printing apparatus. In some embodiments, the components in the binder jetting system (build material, binder composition, coating material, etc.) will be dried before use. In other embodiments, a dry atmosphere may be provided for the printing process.

According to some embodiments, a powder for additive fabrication may comprise powder particles of a primary material (e.g., metal, ceramic, etc.) mixed with at least one alkylidene complex as a catalyst. In some embodiments, the at least one alkylidene complex may include an alkylidene ligand bonded with a metal such as ruthenium or tantalum.

According to some embodiments, an amount of alkylidene catalyst included in the powder compared with an amount of binder composition deposited over the powder may be greater than or equal to 100 ppm, greater than or equal to 200 ppm, greater than or equal to 500 ppm and/or up to 800 ppm, up to 1000 ppm, up to 1600 ppm, or greater by weight or by volume. According to some embodiments, an amount of alkylidene catalyst included in the powder compared with an amount of binder composition deposited over the powder may be in the range 100 ppm to 1600 ppm, by weight or by volume. As one example, for every liter of binder composition deposited onto powder, that powder may contain between 100 mg and 1600 mg of the alkylidene catalyst.

The catalyst may be present in the coating on the build material powder and/or in the binder composition in a relatively large amount. In some embodiments, the catalyst is present in the coating on the build material powder and/or in the binder composition in an amount of greater than or equal to 0.1 wt %, greater than or equal to 0.25 wt %, greater than or equal to 0.50 wt %, greater than or equal to 1 wt %, greater than or equal to 2 wt %, greater than or equal to 5 wt %, greater than or equal to 10 wt %, by weight of the coating and/or the binder composition. In some embodiments, the catalyst is present in the coating on the build material powder and/or in the binder composition in an amount of less than or equal to 50 wt %, less than or equal to 40 wt %, less than or equal to 25 wt %, less than or equal to 20 wt %, less than or equal to 10 wt %, or less by weight of the coating and/or the binder composition.

### Solvent

In some embodiments, a binder composition comprises a solvent. The solvent may solvate the other components therein (e.g., a catalyst therein, a precursor material therein, and activator therein, one or more optional pH modifiers therein, one or more surfactants therein, one or more biocides therein, one or more humectants therein, one or more cross-linking agents therein). In some embodiments, the solvent is a liquid and/or the binder composition is a liquid solution. In some, embodiments, one or more components of the binder composition (e.g., the catalyst and/or precursor material) is at least partially dissolved in the solvent. For example, the amount of any of the binder composition components (e.g., the catalyst and/or the precursor material) dissolved in the solvent of the binder composition may be greater than or equal to 50 wt %, greater than or equal to 80 wt %, greater than or equal to 90 wt %, greater than or equal to 95 wt %, greater than or equal to 98 wt %, greater than or equal to 99 wt %, greater than or equal to 99.9 wt % or more compared to the total weight of that component in the binder composition.

In some embodiments, a binder composition comprises a solvent comprising water. In other words, a binder composition may comprise an aqueous solvent and/or an aqueous solution. Without wishing to be bound by any particular theory, it is believed that aqueous solvents may be desirable for use in binder compositions because they may be more environmentally friendly and/or less toxic than other types of solvents (e.g., than organic solvents).

In certain embodiments, solvents is present (e.g., in the binder composition). The solvent may be used to dilute, convey, or otherwise aid operations involving the precursor material comprising the monomer and/or polymer comprising an unsaturated carbon-carbon bond. The specific type of solvent used may depend upon the monomers and polymers employed. In certain embodiments, a mixture of solvents may be used. Examples of solvents suitable for at least some embodiments include, but are not limited to water and organic solvents. Organic solvents may include polar solvents (e.g., alcohols) and/or nonpolar solvents (e.g., hydrocarbons). Organic solvents may include aprotic solvents and/or protic solvents. Organic solvents may include halogenated solvents and/or non-halogenated solvents. Examples of organic solvents that may be used in at least some embodiments include, but are not limited to ethanol, methanol, propanol, isopropanol, acetic acid, acetone, acetonitrile, anisole, benzene, carbon disulfide, ethyl acetate, petroleum ether, mineral spirits, pyridine, tetrahydrofuran, toluene, xylene, n-hexane, methyl ethyl ketone (MEK), and N-methyl pyrrolidone (NMP). In some embodiments, halogenated solvents (e.g., dichloromethane, chloroform, carbon tetrachloride and ethane dichloride) can be utilized (e.g., with adequate environmental controls). The type and amount of solvent used, either in sole proportion or as part of a mixture, may depend upon the chemical attributes of any monomer(s) and/or polymer(s) to be mixed with the solvent. In some instances, the determination of solvent blends can be anticipated and predicted based upon the chemical form of the various monomer(s) and/or polymer(s), as well as reference to past literature (such as book “Olefin Metathesis” by K. J. Ivin 1983, Academic press, or “Principles of Polymerization” by G. Odian 1991 3^{rd} Ed., Wiley-Interscience), which is incorporated herein by reference. In certain embodiments, a diluent may be a solvent.

One or more of the solvents described above may be present in the binder composition. Solvents suitable for use in the binder compositions described herein may be present in the binder compositions in a variety of suitable amounts. In some embodiments, a binder composition comprises a solvent that makes up greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, or greater than or equal to 40 wt %. In some embodiments, a binder composition comprises a solvent that makes up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, or less than or equal to 5 wt % of the binder composition. Combinations of the above-referenced ranges are also possible (e.g., greater than or equal to 5 wt % and less than or equal to 15 wt %). Other ranges are also possible.

As described above, in some embodiments water is present in the binder composition. In some such cases, water present in the binder composition (e.g., as at least a part of the solvent) makes up greater than or equal to greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, or greater than or equal to 40 wt %. In some embodiments, water present in the binder composition makes up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, or less than or equal to 5 wt % of the binder composition. Combinations of the above-referenced ranges are also possible (e.g., greater than or equal to 5 wt % and less than or equal to 15 wt %). Other ranges are also possible.

### Co-Solvent(s)

Binder compositions comprising a solvent may also comprise one or more co-solvents. The co-solvent(s) may enhance the solubility of one or more components of the binder composition in the solvent (e.g., it may enhance the solubility of one or more monomers and/or polymers, one or more catalysts, one or more pH modifiers, one or more surfactants, one or more biocides, and/or one or more humectants present in the binder composition). The co-solvent(s) may be liquid(s).

Non-limiting examples of suitable co-solvents include solvents that are miscible with the solvent and readily solubilize one or more components of the binder composition. For instance, when the solvent comprises water and the binder composition comprises one or more organic components, one or more water-soluble organic solvents may be suitable for use as co-solvents. Non-limiting examples of suitable co-solvents include alcohols (e.g., monofunctional alcohols, diols, triols), ketones (e.g., acetone, diacetone, butanone), esters (e.g., ethyl acetate), ethers, lactones (e.g., hydroxybutyrolactone), lactams, pyrrolidones (e.g., N-methyl pyrrolidone, N-phenyl pyrrolidone, 2-pyrrolidone), amides (e.g., dimethyl acetamide), nitriles (e.g., acetonitrile), sulfones (e.g., dimethyl sulfone), and sulfoxides (e.g., dimethyl sulfoxide), and combinations thereof. Further examples of alcohols include methanol, ethanol, isopropanol, 1-butanol, 2-butanol, 1,2-hexanediol, ethylene glycol, propylene glycol, 1-(1-hydroxypropoxy)propan-1-ol, 1-(2-hydroxypropoxy)propan-2-ol, 3,3′-oxybis(propan-1-ol), and dipropylene glycol (a mixture of isomers 1-(1-hydroxypropoxy)propan-1-ol, 1-(2-hydroxypropoxy)propan-2-ol, and 3,3′-oxybis(propan-1-ol)).

Co-solvents suitable for use in the binder compositions described herein may be present in the binder compositions in a variety of suitable amounts. In some embodiments, a binder composition comprises a co-solvent or combination of co-solvents that make up greater than or equal to 0 wt %, greater than or equal to 1 wt %, greater than or equal to 2 wt %, greater than or equal to 3 wt %, greater than or equal to 4 wt %, greater than or equal to 5 wt %, greater than or equal to 7.5 wt %, greater than or equal to 10 wt %, greater than or equal to 15 wt %, greater than or equal to 20 wt %, or greater than or equal to 25 wt % of the binder composition. In some embodiments, a binder composition comprises a co-solvent or combination of co-solvents that make up less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 4 wt %, less than or equal to 3 wt %, less than or equal to 2 wt %, or less than or equal to 1 wt % of the binder composition. Combinations of the above-referenced ranges are also possible (e.g., greater than or equal to 0 wt % and less than or equal to 30 wt %, or greater than or equal to 0 wt % and less than or equal to 5 wt %). Other ranges are also possible. It should also be understood that a single co-solvent may be present in a binder composition in one or more of the above-referenced ranges (e.g., that further comprises other, different co-solvents or that lacks other, different co-solvents) and/or the total amount of co-solvent in a binder composition may be in one or more of the above-referenced ranges.

### Surfactant(s)

In some embodiments, a binder composition comprises one or more surfactant(s). The surfactant(s) may increase the penetration of the binder composition into a composite layer and/or may enhance the jetting performance of the binder composition. It is also believed that the surfactants may increase the amount of spreading of the binder composition in a powder layer. In some embodiments, the surfactant(s) may reduce the level of foaming in the binder composition during one or more processes associated with additive manufacturing (e.g., transport to and/or deposition by a print head) and/or may enhance the rate at which the binder composition can refill a print head (e.g., a thermal print head). In some embodiments, at least one surfactant is included in a binder composition to at least modify the surface tension of the binder material. In certain embodiments, the surfactant may be included in a binder material for at least the reasons of (1) droplet formation during the jetting process of the binder composition, (2) tuning imbibition (e.g., speeding up, slowing down, enabling imbibition, and the like) of the binder composition into the build material powder during selective deposition of the binder onto the build material powder. In certain embodiments, the at least one surfactant may be anionic, cationic, zwitterionic, or nonionic.

Some binder compositions may comprise ionic surfactants and some binder compositions may comprise non-ionic surfactants. Non-limiting examples of suitable ionic surfactants include sulfates (e.g., ammonium lauryl sulfate, sodium lauryl sulfate, sodium laureth sulfate, sodium myreth sulfate, perfluorooctanesulfonate, perfluorobutanesulfonate), sulfosuccinates (e.g., dioctyl sodium sulfosuccinate), ethers (e.g., alkyl-aryl ether phosphates, alkyl ether phosphates), sodium stearate, sodium lauroyl sarcosinate, perfluorononanoate, and perfluorooctanoate. Non-limiting examples of suitable non-ionic surfactants include Surfynol 440, Surfynol 2502, Surfynol 604, Thetawet TS 8230, Thetawet FS-8150, polyoxyl 35 castor oil, lauryldimethylamine oxide, Triton X-100, and Dynol 604.

Other non-limiting examples of surfactants that may be used include, but are not limited to Triton X-100, Triton CG-100, Span 20, Span 60, Span 80, Span 85, TWEEN 20, TWEEN 60, TWEEN 80, or IGEPAL CA-720.

In some embodiments, a binder composition comprises a surfactant or combination of surfactants that make up greater than or equal to 0 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.3 wt %, greater than or equal to 0.4 wt %, greater than or equal to 0.5 wt %, greater than or equal to 0.6 wt %, greater than or equal to 0.7 wt %, greater than or equal to 0.8 wt %, greater than or equal to 0.9 wt %, greater than or equal to 1.0 wt %, greater than or equal to 1.25 wt %, greater than or equal to 1.50 wt % of the binder composition, or greater than or equal to 1.75 wt %. In some embodiments, a binder composition comprises a surfactant or combination of surfactants that make up less than or equal to 2 wt %, less than or equal to 1.75 wt %, less than or equal to 1.5 wt %, less than or equal to 1.25 wt %, less than or equal to 1.0 wt %, less than or equal to 0.9 wt %, less than or equal to 0.8 wt %, less than or equal to 0.7 wt %, less than or equal to 0.6 wt %, less than or equal to 0.5 wt %, less than or equal to 0.4 wt %, less than or equal to 0.3 wt %, less than or equal to 0.2 wt %, less than or equal to 0.1 wt %, less than or equal to 0.075 wt %, less than or equal to 0.05 wt %, less than or equal to 0.02 wt %, or less than or equal to 0.01 wt % of the binder composition. In some cases, however, no surfactant is present in the binder composition. Combinations of the above-referenced ranges are also possible (e.g., greater than or equal to 0 wt % and less than or equal to 1 wt %, greater than or equal to 0.01 wt % and less than or equal to 1 wt %, greater than or equal to 0.01 wt % and less than or equal to 0.05 wt %, greater than or equal to 0.1 wt % and less than or equal to 1 wt %, greater than or equal to 0.1 wt % and less than or equal to 0.5 wt %, or greater than or equal to 0.5 wt % and less than or equal to 1 wt %). Other ranges are also possible. It should also be understood that a single surfactant may be present in a binder composition in one or more of the above-referenced ranges (e.g., that further comprises other, different surfactants or that lacks other, different surfactants) and/or the total amount of surfactant in a binder composition may be in one or more of the above-referenced ranges.

### Biocide(s)

In some embodiments, a binder composition comprises one or more biocide(s). The biocide(s) may inhibit the growth of biological species (e.g., bacteria, yeast, fungi) in the binder composition during storage and/or inhibit enzymatic degradation of components of the binder composition during storage.

Binder compositions described herein may comprise one or more biocides that are microbicides and/or one or more biocides that are fungicides. In some embodiments, a binder composition comprises a biocide that is an isothiazolinone, such as ProxelGXL, 1,2-benzisothiazolin-3-one, 4,5-dichloro-2-octyl-4-isothiazolin-3-one, and 2-n-octyl-4-isothiazolin-3-one. Further examples of suitable biocides include 3-(3,4-dichlorophenyl)-1,1-dimethylurea, 2-bromo-2-nitropropane-1,3-diol, lauryldimethylamine oxide, benzalkonium chloride, and/or rotenone.

In some embodiments, a binder composition comprises a biocide or combination of biocides that make up greater than or equal to 0 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.15 wt %, or greater than or equal to 0.2 wt % of the binder composition. In some embodiments, a binder composition comprises a biocide or combination of biocides that make up less than or equal to 0.25 wt %, less than or equal to 0.2 wt %, less than or equal to 0.15 wt %, less than or equal to 0.1 wt %, less than or equal to 0.075 wt %, less than or equal to 0.05 wt %, less than or equal to 0.02 wt %, or less than or equal to 0.01 wt % of the binder composition. Combinations of the above-referenced ranges are also possible (e.g., greater than or equal to 0 wt % and less than or equal to 0.25 wt %). Other ranges are also possible. It should also be understood that a single biocide may be present in a binder composition in one or more of the above-referenced ranges (e.g., that further comprises other, different biocides or that lacks other, different biocides) and/or the total amount of biocide in a binder composition may be in one or more of the above-referenced ranges.

### Humectant(s)

In some embodiments, a binder composition comprises one or more humectants. Non-limiting examples of suitable humectants include alcohols (e.g., mono- or multifunctional alcohols), ethers, lactones, lactams (e.g., substituted lactams, unsubstituted lactams), amides, amines, sulfones, sulfoxides, sulfides, carbonates, and carbamates. Further non-limiting examples of suitable humectants include hydantoin glycol (e.g., Dantocol DHE), 1,3-propanediol, 1,4-butanediol, 1,4-cyclohexanedimethanol, 1,5-pentanediol, 1,6-hexanediol, 1,2-hexanediol, 1,8-octanediol, 1,2-propanediol, 1,2-butanediol, 1,3-butanediol, 2,3-butanediol, ethylene glycol, diethylene glycol, triethylene glycol, tetraethylene glycol, poly(ethylene glycol) having a weight average molecular weight of less than 2000 Da, dipropylene glycol, propylene glycol, polypropylene glycol having weight average molecular weight less than 2000, glycerol, 1,2,6-hexanetriol, sorbitol, 2-pyrrolidone, 1-methyl-2-pyrrolidone, 1-methyl-2-piperidone, N-ethylacetamide, N-methylpropionamide, N-acetyl ethanolamine, N-methylacetamide, formamide, 3-amino-1,2-propanediol, 2,2-thiodiethanol, 3,3-thiodipropanol, tetramethylene sulfone, butadiene sulfone, ethylene carbonate, butyrolactone, tetrahydrofurfuryl alcohol, glycerol, 1,2,4-butenetriol, trimethylpropane, pantothenol, urea, biuret, triethanolamine, and diethanolamine.

In some embodiments, a binder composition comprises a humectant or combination of humectants that makes up less than or equal to 30 wt %, less than or equal to 25 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 2.5 wt %, or less than or equal to 1 wt % of the binder composition. In some embodiments, a binder composition comprises a humectant or combination of humectants that makes up greater than or equal to 0 wt %, greater than or equal to 1 wt %, greater than or equal to 2.5 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, or greater than or equal to 25 wt % of the binder composition. Combinations of the above-referenced ranges are also possible (e.g., less than or equal to 30 wt % and greater than or equal to 0 wt %). Other ranges are also possible. It should also be understood that a single humectant may be present in a binder composition in one or more of the above-referenced ranges (e.g., that further comprises other, different humectants or that lacks other, different humectants) and/or the total amount of humectant in a binder composition may be in one or more of the above-referenced ranges.

An example of a suitable binder composition may comprise one or more cyclic olefins (e.g., dicyclopentadiene) mixed with one or more surfactants and/or humectants. The cyclic olefins may for instance be supplied as the PCX01 mixture from NexTene™, which contains dicyclopentadiene at between 90 wt % and 98 wt %. An example of a suitable catalyst may include B component from NexTene™.

### Chain Transfer Agents

In certain embodiments, a chain transfer agent is present in the coating on the build material powder and/or the binder composition. The chain transfer agent may aid in the polymerization of block co-polymers or telechelic polymers, according to some embodiments. The ability to form block (di- and multi-block, for example) and/or telechelic polymers may add additional degrees of design freedom to achieve a desired strength of a binder-jetted part via tuned surface interactions and/or mechanical properties of a polymerized chain, for example. In certain embodiments, a chain transfer agent is a symmetrical or a non-symmetrical molecule. In certain embodiments, a chain transfer agent is an unsaturated olefinic molecule. In certain embodiments, a chain transfer agent contains a benzene ring. In certain embodiments, a chain transfer agent may comprise a 1-3,diene and styrene.

### Inhibitors

In certain embodiments, an inhibitor is present in the coating on the build material powder and/or the binder composition. In some instances it is desirable to control the reactivity of a formulation through the incorporation of stabilizing additives (such as inhibitors) to improve the lifetime of the formulation mixture. Inhibitors may prevent or reduce the premature reaction of the reactive species (e.g., monomers and polymers) with the catalyst. Inhibitors may retard catalytic activity through the occlusion of the catalyst's active sites. This may be done by using a ligand that effectively competes with reactive species for the active site and it tailored to the specific catalyst of choice. For example, 2^{nd} Generation Grubbs catalyst (Nitrogen-heterocyclic carbene (NCH) and tricyclophosphine ligands) can be inhibited with a 1:1 addition of tributyl phosphite (see, e.g., Dean, L. et al ACS Macro Lett. 2020, 9, 819-824). In certain embodiments, inhibitor molecules, including phosphorous and nitrogen containing ligands, may be added to the formulation (e.g., in the coating and/or in the binder composition to improve shelf-life and pot-life of the reactive species.

### Antioxidants

In certain embodiments, an antioxidant is present in the coating on the build material powder and/or the binder composition. In some instances it is desirable to control the aging of a final part (e.g., the build material object) through the incorporation of stabilizing additives (antioxidants) to improve the lifetime of the final printed (functional) part, according to some embodiments. In some embodiments a binder composition may be used as a sacrificial scaffold that is burned out during a sintering process. In other embodiments, the binder is used to form a functional part. To extend the lifetime of functional parts, protection against oxidation (leading to premature embrittlement) may be desirable. This may be especially true when a preponderance of unsaturated bonds exists (such as in polymerized olefins via olefin metathesis). The incorporation of radical scavengers (such as, but not limited to, hydroquinone (HQ), methyl hydroquinone (MEHQ), ditertbutyl hydroxytoluene (BHT) or Irganox 1010) into the formulation may significantly reduce the rate of oxidation (aging and embrittlement) and prolong the lifetime of the functional part. In some embodiments, stabilizing additives, such as antioxidants, may be included to account, compensate for, or sequester oxidative reactions that may occur during processing owing to the presence of oxidizing species present in the processing environment, including the print chamber, or post-processing operations such as drying, post-cure operations, and depowdering. In certain embodiments, antioxidants are included in the binder composition. In certain embodiments, antioxidants are included as a component in a coating on the build material powder. In certain embodiments, antioxidants are included on inert filler materials such as flow aids or other finely divided solid filler materials.

Binders compositions used in an additive manufacturing process (e.g., in a binder jet printing process) may be selected and/or designed to satisfy any of variety of properties. Accordingly, a binder composition may be designed or constructed to exhibit any of a variety of characteristics. Among the various properties that may be desirable in at least some embodiments are those relating to chemical and physical compatibility between the binder composition and other objects that the binder composition contacts and/or operates near and within. One skilled in the art will appreciate that there may not be a clear division between what may be constituted as a chemical or physical compatibility requirement or attribute; that is, certain requirements may be considered by a first practitioner as a chemical attribute, while the same attribute may be considered as a physical attribute by a second practitioner. As described herein, any divisions or labeling of phenomena as ‘chemical’ or ‘physical’ are chosen for the ease of description and the improved conveyance of aspects of this disclosure.

Examples of properties desirable in at least some embodiments based upon chemical compatibility include, but are not limited to (1) the binder composition not dissolving, swelling, causing to crack, crazing, reacting with, fracturing, or otherwise degrade the wetted surface of the binder supply system (e.g., binder supply reservoir, pumps, sensors, supply lines, printhead manifolds, and the like) to which the binder composition comes in contact, (2) the binder composition being tolerant of certain amounts of water vapor and/or oxygen present in the environment in which the binder composition is processed or stored, (3) the binder composition's components being non-flammable (under a defined set of conditions that may include a flash point above a certain threshold), non-carcinogenic, or imposing no harm to human reproductive health.

Examples of properties desirable in at least some embodiments based upon physical compatibility include, but are not limited to: (1) the ability of the binder composition to be jetted repeatably without the presence of satellites or other extraneous fluid ejecta, (2) the ability for the binder composition to remain liquid (or otherwise refrain from drying, solidifying, or increasing in viscosity) when the binder composition is present within the printhead, (3) maintaining a specific range of viscosity to ensure property jetting operation and droplet formation, and (4) maintaining a specific range of surface tension to ensure proper jetting operation and droplet formation.

### Build Material Powder

As described above, any of a variety of build material may be employed for the build material powder in the techniques described in this disclosure. In some embodiments, the build material powder comprises a plurality of particles. The particles may be finely divided materials (e.g., finely divided to a size fine enough for processing (including, for example, at least handling, metering, spreading, and packing, among other process steps).

In some embodiments, the build material powder comprises metal and/or a metal alloy (e.g., metal particles and/or metal alloy particles). Examples of metals that can be used in the build material powder include, but are not limited to titanium, vanadium, chromium, manganese, iron, nickel, copper, zinc, zirconium, niobium, molybdenum, ruthenium, rhodium, palladium, silver, cadmium, tungsten, rhenium, osmium, iridium, platinum, gold, and combinations and/or alloys thereof. In some embodiments, the build material comprises an alloy of iron (e.g., steel). In certain embodiments, alloys of stainless steel (e.g., 17-4 stainless steel, 316 and 316L stainless, 310 stainless, 304 stainless, 420 stainless,), carbon steel (e.g., 4140, 4340, 4605), tool steel (e.g., A2, D2, H13, S7, O1) are used for the build material. In some embodiments, aluminum alloys and aluminum casting alloys (e.g., 6061, 7075, 2025, A356, A380) are used for the build material. In some embodiments, copper and/or a copper alloy (e.g., elemental copper, chromium zirconium copper are used for the build material). In some embodiments, alloys of nickel (e.g., Inconel 625, Inconel 718) are used for the build material. In some embodiments, the metal and/or metal alloy is present in the build material in an amount of greater than or equal to 50 wt %, greater than or equal to 80 wt %, greater than or equal to 90 wt %, greater than or equal to 95 wt %, greater than or equal to 95 wt %, greater than or equal to 99 wt %, greater than or equal to 99.9 wt %, or higher (e.g., 100 wt %) by weight of the build material.

In some embodiments, the build material comprises a ceramic. In some embodiments, the build material powder comprises an oxide ceramic or refractory (e.g., alumina, mullite, silica, magnesia, zircon, zirconia, yttria stabilized zirconia). In some embodiments, the build material comprises a non-oxide ceramic refractory (e.g., a metal carbide, a nitride, a disilicide, a borides). In some embodiments, the ceramic is present in the build material in an amount of greater than or equal to 50 wt %, greater than or equal to 80 wt %, greater than or equal to 90 wt %, greater than or equal to 95 wt %, greater than or equal to 95 wt %, greater than or equal to 99 wt %, greater than or equal to 99.9 wt %, or higher (e.g., 100 wt %) by weight of the build material.

In some embodiments, the build material powder comprises a mixture of various classes of materials (e.g., for composites). For example, a first portion of the build material powder may comprise particles of a metal and/or metal alloy and a second portion of the build material powder may comprise particles of ceramic. The first portion and the second portion may be deposited separately or mixed (e.g., homogeneously).

The build material powders described herein may comprise a plurality of build material particles having a variety of suitable sizes. The size of the particles may be on the order of nanometers (e.g., median diameters as low as 10 nm) to as large as millimeters (e.g., a median diameter as high as 10 mm). In some embodiments, a build material powder may comprise a plurality of particles having a size suitable for the formation of build material objects by additive manufacturing methods (e.g., that have good flow behavior and/or are suitable for sintering). For instance, the plurality of particles may have an advantageous value of D50 (i.e., an advantageous median particle size). In some embodiments, the plurality of particles has a D50 of greater than or equal to 3 microns, greater than or equal to 5 microns, greater than or equal to 6 microns, greater than or equal to 7 microns, greater than or equal to 9 microns, greater than or equal to 10 microns, greater than or equal to 12.5 microns, greater than or equal to 13 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 100 microns, or greater. In some embodiments, the plurality of particles has a D50 of less than or equal to 500 microns, less than or equal to 200 microns, less than or equal to 150 microns, less than or equal to 100 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 13 microns, less than or equal to 12.5 microns, less than or equal to 10 microns, less than or equal to 9 microns, less than or equal to 7 microns, or less. Combinations of the above-referenced ranges are also possible (e.g., greater than or equal to 3 microns and less than or equal to 500 microns, greater than or equal to 5 microns and less than or equal to 15 microns, greater than or equal to 10 microns and less than or equal to 25 microns, greater than or equal to 20 microns and less than or equal to 50 microns, greater than or equal to 45 microns and less than or equal to 150 microns, or greater than or equal to 100 microns and less than or equal to 500 microns). Other ranges are also possible. The D50 of a plurality of particles may be determined in accordance with ASTM E2651-13. As one skilled in the art will appreciate, various properties of the build material powder may be dependent upon the measure of size and the size distribution of a build material powder.

The build material powder may possess any of a variety of morphologies including various shapes and surface characteristics. Build material powders may be spherical, prolate, oblate, fiber-like, disc-like, dendritic, elongated, irregular, decorated with smaller satellite particles (e.g., satellited), angular, ligamented, cylindrical, cuboidal, tear drop shaped, rounded, spheroidal, among other possible shapes. Similarly, in certain embodiments, the surface of the build material powders may be smooth (relative to the characteristic size of the powder) such that a characteristic roughness (as measured by Ra, for example) may be from 100 to 1000 times (or more) smaller than the characteristic size of the build material powder. In some embodiments, the surface of the build material powders may be rough (relative to the characteristic size of the powder) such that a characteristic roughness (as measured by Ra, for example) may be between 1 and 100 times (or more) smaller than the characteristic size of the build material powder. As one skilled in the art will appreciate, various properties of the build material powder may be dependent upon the roughness, and relative roughness as compared to a measure of the build material powder size, of a build material powder.

The surface of the build material powder grains may establish a region of interaction with other build material powder grains and/or with other materials, including binder composition components and coatings, that may be brought into contact with the build material powder. As such, various physicochemical properties of the powder surface (such as surface area per volume, total surface area, surface chemistry, exposed chemical groups, surface atoms, adsorbed gases and liquids and the like) may be important in affecting various interactions between the build material powder and any of variety of materials brought into contact with the build material powder (such as components of the binder composition, coatings, and other powders). In certain embodiments, physicochemical surface properties of the build material powder may affect, for example, the wetting and adhesion properties of a binder applied to the build material powder, the wetting, adhesion, and coating thickness and uniformity of a coating applied to the build material powder, cohesive interactions between and among the various grains of build material powder, as well as the uptake of a coating material applied to a build material powder. In certain embodiments, a variety of surface interactions are affected by the presence of water adsorbed on the surface of the powder, which may include both or either of physisorption and chemisorption of water. Particle conditioning (mixing, drying, roughness modification) may also affect surface interactions.

In some instances, the interaction of the build material powder (e.g., uncoated build material powder) and other components to which it may come into contact (e.g., a coating, a binder composition) can be facilitated by the presence of one or more functional groups on the surface of the particles of the build material powder. For example, the surface may comprise functional groups on the surface that can promote the wetting of the binder composition on the surface of the build material powder. In some embodiments, the surface has a higher surface energy than the binder composition (e.g., due the functional groups). This may result in the total energy of the system being lowered upon the binder composition wetting the surface of the build material powder (and thus being thermodynamically favorable). Examples of functional groups that may be included on the surface include, but are not limited to, metal hydroxides, metal nitrides, and epoxide-linkages between metals. Examples of adsorbed gases include, but are not limited to water vapor (water), oxygen gas, nitrogen gas, and carbon dioxide In certain cases, such as with stainless steels, alloying elements that are present in the build material powder in a minority amount may be enriched on the surface. For example, materials such as chromium (and/or its oxides), nickel (and/or its oxides), aluminum (and/or its oxides), silicon (and/or its oxides), and/or other elements may be present on the surface of a build material powder in a higher concentration as compared to their concentration (if present at all) in the bulk of the build material powder or the composition of the build material in wrought form.

In instances where the build material powder is coated (e.g., with a catalyst and/or the precursor material and one or more other components), then there may be three regions of interest to consider in the system: (1) the surface of the build material powder particles, (2) the interface between the coating and surface of the build material powder particles, and (3) the interface between the coating and other components to which the coated build material may be exposed (e.g., the binder composition). The coating may be tuned to promote desirable interactions with the build material (e.g., through polar group interactions and/or potentially through ligating groups such as phosphoric acid groups). The same coating material may also be tuned to promote desirable interactions with the binder composition. Examples of materials that may be present in the coating on the particles of the build material (e.g., in addition to the catalyst and/or precursor material) include, but are not limited to aliphatic systems with polar groups (e.g., poly(acrylic acid), poly(ethyl imine), poly(vinyl alcohol), poly urethanes, acrylics (e.g., phosphoric acid functionalized acrylic systems), nylons (including nylon copolymers (such as PEBAX), and combinations thereof.

As described above, certain embodiments relate to methods of additive manufacturing by binder jet printing. Further details regarding such embodiments and the articles produced by methods of additive manufacturing are provided below.

As also described above, some methods of additive manufacturing comprise depositing a binder composition on a layer of build material powder. The layer of build material powder may be a layer that comprises a plurality of particles that are not adhered together. For instance, the build material particles in a layer of build material powder may be readily separated from each other by the application of minimal amounts of force, such as the application of forces present during typical processes of depositing a layer of build material powder and/or the application of gravity.

When present, layers of build material powder may have any of a variety of suitable thicknesses. In some embodiments, a layer of build material powder has a thickness of greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 60 microns, greater than or equal to 70 microns, greater than or equal to 80 microns, or greater than or equal to 90 microns. In some embodiments, a layer of build material powder has a thickness of less than or equal to 200 microns, less than or equal to 150 microns, less than or equal to 125 microns, less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, or less than or equal to 20 microns. Combinations of the above-referenced ranges are also possible (e.g., greater than or equal to 10 microns and less than or equal to 200 microns, or greater than or equal to 25 microns and less than or equal to 100 microns). Other ranges are also possible.

Once a layer of build material powder has been deposited, deposition of a binder composition thereon may occur (e.g., by means of a print head, such as an ink jet print head, that ejects a plurality of droplets) at a variety of suitable velocities. In some embodiments, the binder composition is deposited at a velocity of greater than or equal to 3 m/s, greater than or equal to 4 m/s, greater than or equal to 5 m/s, greater than or equal to 6 m/s, greater than or equal to 7 m/s, greater than or equal to 8 m/s, greater than or equal to 9 m/s, greater than or equal to 10 m/s, or greater than or equal to 11 m/s. In some embodiments, the binder composition is deposited at a velocity of less than or equal to 12 m/s, less than or equal to 11 m/s, less than or equal to 10 m/s, less than or equal to 9 m/s, less than or equal to 8 m/s, less than or equal to 7 m/s, less than or equal to 6 m/s, less than or equal to 5 m/s, or less than or equal to 4 m/s. Combinations of the above-referenced ranges are also possible (e.g., greater than or equal to 3 m/s and less than or equal to 12 m/s greater than or equal to 6 m/s and less than or equal to 12 m/s). Other ranges are also possible. Binder composition velocity may be measured using a high speed camera, or a stroboscope/camera apparatus, with imaging software. The velocity may be measured when droplets of the binder composition are 0.5 mm from the orifice of the print head from which they are ejected.

In some embodiments, a binder composition is deposited in the form of droplets. For instance, in some embodiments, a step of depositing a binder composition on layer of build material powder comprises producing a droplet of the binder composition and depositing the droplet of the binder composition on the layer of build material powder. When produced, droplets may have a variety of suitable volumes. In some embodiments, a method comprises producing a droplet having a volume of greater than or equal to 0.5 pL, greater than or equal to 0.75 pL, greater than or equal to 1 pL, greater than or equal to 1.5 pL, greater than or equal to 2 pL, greater than or equal to 3 pL, greater than or equal to 5 pL, greater than or equal to 7.5 pL, greater than or equal to 10 pL, greater than or equal to 12 pL, greater than or equal to 15 pL, greater than or equal to 20 pL, greater than or equal to 25 pL, greater than or equal to 30 pL, or greater than or equal to 35 pL. In some embodiments, a method comprises producing a droplet having a volume of less than or equal to 40 pL, less than or equal to 35 pL, less than or equal to 30 pL, less than or equal to 25 pL, 20 pL, less than or equal to 15 pL, less than or equal to 12 pL, less than or equal to 10 pL, less than or equal to 7.5 pL, less than or equal to 5 pL, less than or equal to 3 pL, less than or equal to 2 pL, less than or equal to 1.5 pL, less than or equal to 1 pL, or less than or equal to 0.75 pL. Combinations of the above-referenced ranges are also possible (e.g., greater than or equal to 0.5 pL and less than or equal to 40 pL, greater than or equal to 0.5 pL and less than or equal to 20 pL, greater than or equal to 0.5 pL and less than or equal to 2 pL, greater than or equal to 2 pL and less than or equal to 20 pL, or greater than or equal to 2 pL and less than or equal to 12 pL). Other ranges are also possible. Droplet volume may be measured using a high speed camera, or a stroboscope/camera apparatus, with imaging software as described in the examples. It should also be understood that some methods may comprise producing a plurality of droplets comprising one or more droplets having a volume in one or more of the above-referenced ranges and that some methods may comprise producing a plurality of droplets having an average volume in one or more of the above-referenced ranges.

In some embodiments in which a plurality of droplets of a binder composition are produced, they may be produced in a manner such that they have a relatively uniform volume. Production of droplets with relatively uniform volumes may enhance the precision with which features in a composite layer can be formed, as it may allow more control over the amount and location of the binder composition in the composite layer by reducing the amount of unwanted droplets and/or droplets of unwanted volumes. Volume uniformity may enhance control over the volumetric ratio of the binder composition to the build material powder on which it is deposited, which may promote better control over the properties of the build material object fabricated therefrom.

In some embodiments, a plurality of droplets comprises almost exclusively main droplets and very few satellite droplets. In other words, the binder composition may form droplets in a manner that does not substantially form satellite droplets. The satellite droplets may be droplets having a smaller volume than the main droplets. In some embodiments, satellite droplets have a volume of less than or equal to 1.5 pL, less than or equal to 1 pL, or less than or equal to 0.5 pL. For instance, in some embodiments, less than 1% of the droplets within a plurality of droplets are satellite droplets (e.g., less than 1% of the droplets have a volume of less than or equal to 1.5 pL, less than or equal to 1 pL, or less than or equal to 0.5 pL when the main droplets have a volume of greater than or equal to 0.5 pL, greater than or equal to 1 pL, or greater than or equal to 1.5 pL). In some embodiments, a plurality of droplets comprises exclusively main droplets and no satellite droplets and/or a binder formulation forms droplets in a manner that does not form satellite droplets. The presence of satellite droplets, and their amount, may be determined by using the technique described for measuring droplet volume described above.

Droplets of a binder composition may be produced in a variety of suitable manners. In some embodiments, one or more droplets of a binder composition are produced by a print head, such as a piezoelectric print head or a thermal print head. Without wishing to be bound by any particular theory, it is believed that piezoelectric print heads may be configured to form larger droplets comprising a binder composition than thermal print heads (e.g., piezoelectric print heads may be configured to form droplets having volumes of greater than or equal to 2 pL and less than or equal to 20 pL, while thermal print heads may be configured to form droplets having volumes of greater than or equal to 0.5 pL and less than or equal to 2 pL). Non-limiting examples of suitable print heads include SAMBA (FujiFilm Co.), SG-1024 (Fujifilm Co.), XAAR 5601 (XAAR, plc), VersaPass (Memjet), Duralink (Memjet), and Duraflex (Memjet).

As described above, certain embodiments relate to three-dimensional compositions. The three-dimensional compositions may include a build material powder and a binder composition. The binder composition may comprise one or more of the components described elsewhere herein with respect to binder compositions (e.g., a solvent, a catalyst, a precursor material, a reaction product thereof, and/or an optional surfactant or co-solvent. In some embodiments, the three-dimension composition comprises a polymer formed from a metathesis chain-growth polymerization reaction (e.g., a polymer formed from a ROMP reaction during and/or following deposition of the binder composition on at least a portion of a deposited layer of build material powder).

As described above, certain, but not necessarily all embodiments relate to the drying and/or cross-linking of a binder composition, and certain but not necessarily all embodiments relate to build material-based composite structures formed by the drying and/or cross-linking of a binder composition positioned in a three-dimensional composition. Further details regarding such embodiments are provided below. In some instances, only drying is performed in part because the presence of a polymer formed from a metathesis chain-growth polymerization reaction (e.g., a polymer formed from a ROMP reaction during and/or following deposition of the binder composition on at least a portion of a deposited layer of build material powder) provides sufficient strength such that separate cross-linking in unnecessary. In some embodiments, not curing (e.g., no drying or cross-linking) is performed.

As also described above, the curing (e.g., drying and/or cross-linking) of a binder composition may be accomplished by exposing the binder composition to a stimulus that is heat. The temperature to which the binder composition is heated may be sufficient to dry and/or cross-link the binder composition without appreciably degrading the portion(s) of the binder composition, if any, configured to remain in the build material-based composite structure during this step. In some embodiments, curing (e.g., drying and/or cross-linking) a binder composition comprises heating an environment in which a three-dimensional composition is positioned to a temperature of greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., greater than or equal to 220° C., greater than or equal to 230° C., or greater than or equal to 240° C. In some embodiments, curing (e.g., drying and/or cross-linking) a binder composition comprises heating an environment in which the three-dimensional composition is positioned to a temperature of less than or equal to 250° C., less than or equal to 240° C., less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., or less than or equal to 100° C. Combinations of the above-referenced ranges are also possible (e.g., greater than or equal to 90° C. and less than or equal to 250° C., greater than or equal to 120° C. and less than or equal to 220° C.). Other temperatures are also possible. The temperature chosen for the environment during the drying and/or cross-linking may depend on the composition of the environment (e.g., to avoid prematurely de-binding). For example, in some embodiments in which the heating environment is an oxidative gaseous environment (e.g., air), the environment may be heated to a temperature of less than or equal to 220° C., while in some embodiments in which the heating environment is an inert environment, the environment may be heated to a temperature of less than or equal to 250° C. The temperature of an environment may be determined by use of a thermocouple positioned in the environment.

Non-limiting examples of suitable environments in which a three-dimensional composition may be positioned during drying and/or heating of the binder composition include an oven and a powder bed. The relevant environment may comprise a variety of suitable types of gases. By way of example, the relevant environment may comprise an oxidative environment such as air, may comprise hydrogen, and/or may comprise an inert gas (e.g., nitrogen, argon, helium). Certain gas species (e.g., hydrogen, helium) may contribute to a relatively high thermal conductivity during drying and/or heating. In some embodiments, the relevant environment may lack species that are reactive at the temperature to which the environment is heated. By way of example, the relevant environment may be an inert environment (e.g., it may comprise, consist essentially of, and/or consist of an inert gas such as nitrogen and/or argon). The pressure of the relevant environment may generally be selected as desired. Some relevant environments may be at atmospheric pressure; some may be at a pressure less than atmospheric pressure.

Drying and/or heating a three-dimensional composition may be performed for a variety of suitable amounts of time. The time may be selected to provide a desired level of drying and/or cross-linking of the binder composition. By way of example, if a light level of drying and/or cross-linking is desired, a drying and/or cross-linking step may be performed for a relatively short time. Similarly, if a relatively high level of drying and/or cross-linking is desired, a drying and/or cross-linking step may be performed for a relatively long time. In some embodiments, a drying and/or cross-linking step comprises heating an environment in which a three-dimensional composition is positioned for a time period of greater than or equal to 15 minutes, greater than or equal to 30 minutes, greater than or equal to 45 minutes, greater than or equal to 1 hour, greater than or equal to 90 minutes, greater than or equal to 2 hours, greater than or equal to 3 hours, greater than or equal to 4 hours, greater than or equal to 5 hours, greater than or equal to 6 hours, greater than or equal to 8 hours, greater than or equal to 10 hours, greater than or equal to 12 hours, greater than or equal to 14 hours, greater than or equal to 16 hours, greater than or equal to 18 hours, greater than or equal to 20 hours, greater than or equal to 1 day, greater than or equal to 2 days, greater than or equal to 3 days, greater than or equal to 4 days, greater than or equal to 100 hours, greater than or equal to 5 days, or greater than or equal to 6 days. In some embodiments, a drying and/or cross-linking step comprises heating an environment in which a three-dimensional composition is positioned for a time period of less than or equal to 1 week, less than or equal to 6 days, less than or equal to 5 days, less than or equal to 100 hours, less than or equal to 4 days, less than or equal to 3 days, less than or equal to 2 days, less than or equal to 1 day, less than or equal to 20 hours, less than or equal to 18 hours, less than or equal to 16 hours, less than or equal to 14 hours, less than or equal to 12 hours, less than or equal to 10 hours, less than or equal to 8 hours, less than or equal to 6 hours, less than or equal to 5 hours, less than or equal to 4 hours, less than or equal to 3 hours, less than or equal to 140 minutes, less than or equal to 120 minutes, or less than or equal to 100 minutes. Combinations of the above-referenced ranges are also possible (e.g., greater than or equal to 15 minutes and less than or equal to 6 days, greater than or equal to 15 minutes and less than or equal to 120 minutes, or greater than or equal to 45 minutes and less than or equal to 120 minutes). Other ranges are also possible.

In some embodiments, drying and/or heating a three-dimensional composition comprises heating the environment in which the three-dimensional composition is positioned to one temperature in one or more of the above-referenced ranges and holding the temperature of the environment thereat for an amount of time in one of the above-referenced ranges. In some embodiments, drying and/or heating a three-dimensional composition comprises heating an environment in which the three-dimensional composition is positioned to two or more temperatures in the above-referenced ranges sequentially and holding the temperature of the environment at each of the two or more temperatures. In such embodiments, the relevant environment may be held at each of the relevant temperatures for a period of time in one or more of the above-referenced ranges and/or may be heated such that the total time it is held at all of the relevant temperatures is in one or more of the above-referenced ranges.

In some embodiments, drying and/or heating a three-dimensional composition is performed in a manner that reduces the tendency of the three-dimensional object to form cracks. For instance, drying and/or heating a three-dimensional composition may be performed in a manner such that changes between temperatures are performed relatively slowly. In some embodiments, drying and/or heating a three-dimensional composition is performed such that the change in temperature of the environment in which the three-dimensional object is positioned is less than or equal to 2° C./min, less than or equal to 1.5° C./min, less than or equal to 1° C./min, at less than or equal to 0.75° C./min, less than or equal to 0.5° C./min, or less than or equal to 0.25° C./min. In some embodiments, drying and/or heating a three-dimensional composition is performed such that that the change in temperature of the environment in which the three-dimensional composition is positioned is greater than or equal to 0.1° C./min, greater than or equal to 0.25° C./min, greater than or equal to 0.5° C./min, greater than or equal to 0.75° C./min, greater than or equal to 1° C./min, greater than or equal to 1.5° C./min. Combinations of the above-referenced ranges are also possible (e.g., greater than or equal to 2° C./min and less than or equal to 0.1° C./min). Other ranges are also possible. In some embodiments, the temperature of the environment in which the three-dimensional composition is positioned is either constant or changes at a rate in one or more of the ranges described above throughout a drying and/or cross-linking process. In some embodiments, a drying and/or cross-linking process comprises a change in temperature at a rate in one or more of the ranges described above but also comprises further changes in temperature (e.g., at a rate in one or more of the ranges described above, at a rate outside of the ranges described above).

As described above, certain embodiments relate to build material-based composite structures. Further details regarding such embodiments are provided below.

In some embodiments, a build material-based composite structure is provided. The build material-based composite structure may comprise a build material powder (e.g., a metal powder comprising a noble metal or noble metal alloy) coated at least in part with a precursor material (and/or a catalyst), one or more components of a binder composition that include a catalyst (and/or a precursor material) and/or one or more reaction products of one or more components of a binder composition (e.g., a polymer formed from a metathesis chain-growth polymerization reaction (e.g., a polymer formed from a ROMP reaction during and/or following deposition of the binder composition on at least a portion of a deposited layer of build material powder)).

In some embodiments, a build material-based composite structure comprises a polymer binder. For instance, the polymer binder may adhere to particles positioned in the composite layer and may have sufficient cohesive strength to form a self-supporting structure in which the particles are embedded.

A build material powder present in a build material-based composite structure may make up any suitable amount thereof. In some embodiments, the build material powder makes up greater than or equal to 92 wt %, greater than or equal to 93 wt %, greater than or equal to 94 wt %, greater than or equal to 95 wt %, greater than or equal to 96 wt %, greater than or equal to 97 wt %, greater than or equal to 98 wt %, greater than or equal to 99 wt %, or greater than or equal to 99.8 wt % of the build material-based composite structure. In some embodiments, the build material powder makes up less than or equal to 99.9 wt %, less than or equal to 99.5 wt %, less than or equal to 99 wt %, less than or equal to 98 wt %, less than or equal to 97 wt %, less than or equal to 96 wt %, less than or equal to 95 wt %, less than or equal to 94 wt %, or less than or equal to 93 wt % of the metal-based composite structure. Combinations of the above-referenced ranges are also possible (e.g., greater than or equal to 92 wt % and less than or equal to 99.9 wt %, greater than or equal to 96 wt % and less than or equal to 99.9 wt %, or greater than or equal to 97 wt % and less than or equal to 99.8 wt %). Other ranges are also possible. In some embodiments, the metathesis chain-growth polymerization reaction products make up at least 50 wt %, at least 80 wt %, at least 90 wt %, at least 95 wt %, at least 99 wt %, or more of the balance of the build material-based composite that is not made up of the build material powder.

The build material-based composite structures described herein may have advantageously have relatively high transverse flexural strengths. Desirably, high values of transverse flexural strength may reduce the tendency of build material-based composite structures to fail during further additive manufacturing steps. In some embodiments, a build material-based composite structure has a transverse flexural strength of greater than or equal to 1 MPa, greater than or equal to 2 MPa, greater than or equal to 3 MPa, greater than or equal to 5 MPa, greater than or equal to 7.5 MPa, greater than or equal to 10 MPa, greater than or equal to 20 MPa, greater than or equal to 50 MPa, greater than or equal to 75 MPa, greater than or equal to 100 MPa, or greater than or equal to 125 MPa. In some embodiments, a build material-based composite structure has a transverse flexural strength of less than or equal to 150 MPa, less than or equal to 125 MPa, less than or equal to 100 MPa, less than or equal to 75 MPa, less than or equal to 50 MPa, less than or equal to 20 MPa, less than or equal to 10 MPa, less than or equal to 7.5 MPa, less than or equal to 5 MPa, or less than or equal to 2 MPa. Combinations of the above-referenced ranges are also possible (e.g., greater than or equal to 1 MPa and less than or equal to 150 MPa, greater than or equal to 2 MPa and less than or equal to 150 MPa, or greater than or equal to 3 MPa and less than or equal to 100 MPa). Other ranges are also possible. The presence of a polymer formed from a metathesis chain-growth polymerization reaction may contribute, at least in part, to such high strengths.

The transverse flexural strength of a build material-based composite structure may be the transverse flexural strength as determined by the three-point bending test described in ASTM B312-14 and/or may be the transverse flexural strength as determined by the four-point bending test described in ASTM C1161-18. In other words, some build material-based composite structures may have transverse flexural strengths as determined by the three-point bending test described in ASTM B312-14 in one or more of the above-referenced ranges, some build material-based composite structures may have transverse flexural strengths as determined by the four-point bending test described in ASTM C1161-18 in one or more of the above-referenced ranges, and some build material-based composite structures may have transverse flexural strengths as determined by the three-point bending test described in ASTM B312-14 and as determined the four-point bending test described in ASTM C1161-18 in one or more of the above-referenced ranges.

As described above, certain embodiments relate to heating build material-based composite structures. Certain embodiments relate to de-bound build material structures formed by heating build material-based composite structures (e.g., during step 70 in FIGS. 1A-1B). Further details regarding such embodiments are provided below.

De-bound build material structures may advantageously include relatively low levels of certain elements. For instance, in some embodiments, a de-bound build material structure comprises relatively small amounts of carbon and/or oxygen. As described elsewhere herein, such components may react undesirably with the build material in the de-bound build material structure during further additive manufacturing steps (e.g., during a sintering step). By way of example, carbon in a de-bound build material structure may react undesirably with surface oxides also therein.

In some embodiments, carbon makes up less than or equal to 0.5 wt %, less than or equal to 0.4 wt %, less than or equal to 0.2 wt %, less than or equal to 0.1 wt %, less than or equal to 0.05 wt %, or less than or equal to 0.02 wt % of the de-bound build material structure. In some embodiments, carbon makes up greater than or equal to 0 wt %, greater than or equal to 0.02 wt %, greater than or equal to 0.05 wt %, greater than or equal to 0.1 wt %, greater than or equal to 0.2 wt %, or greater than or equal to 0.4 wt % of the de-bound build material structure. Combinations of the above-referenced ranges are also possible (e.g., less than or equal to 0.5 wt % and greater than or equal to 0 wt %, or less than or equal to 0.1 wt % and greater than or equal to 0 wt %). Other ranges are also possible. The amount of carbon in the de-bound build material structure may be determined in accordance with ASTM E1019.

In some embodiments, oxygen makes up less than or equal to 1.5 wt %, less than or equal to 1.3 wt %, or less than or equal to 1.1 wt % of the de-bound build material structure. The amount of oxygen in the de-bound build material structure may be determined in accordance with ASTM E1019.

As described above, certain embodiments relate to the formation of build material objects from de-bound build material structures and/or composite build material structures. Certain embodiments relate to build material objects. Further details regarding such embodiments are provided below.

Some build material objects described herein advantageously both comprise a build material and have a density that is relatively close to the density of the build material included therein. Build material objects having this property may include a relatively low amount of internal pores (i.e., pores included in the bulk of the build material object and not in fluidic communication with an environment external to the build material object) and/or may include internal pores that make up a relatively small volume fraction of the build material object. Low amounts and/or volume fractions of internal pores may desirably increase the robustness and strength of the build material object.

The relationship between the density of a build material object and the density of a build material alloy included therein may be parametrized by a relative density. As used herein, the relative density may be computed by dividing the bulk density of the build material object by the bulk density of the relevant build material alloy and multiplying by 100%. Accordingly, a relative density of 100% would indicate that the build material object has a density identical to the bulk build material alloy included therein while a relative densities of less than 100% would indicate that the build material object has a density less than the build material alloy included therein. The bulk density of a build material object may be computed in accordance with ASTM B962-17. It should be understood that internal pores would contribute to this volume (because they are entirely enclosed by the outer boundary of the build material object) while open pores and other features partially enclosed by a build material object would not contribute to this volume.

In some embodiments, a build material object has a relative density of greater than or equal to 90%, greater than or equal to 91%, greater than or equal to 92%, greater than or equal to 93%, greater than or equal to 94%, greater than or equal to 95%, greater than or equal to 96%, greater than or equal to 97%, greater than or equal to 98%, or greater than or equal to 99%. In some embodiments, a build material object has a relative density of less than or equal to 100%, less than or equal to 99.9%, less than or equal to 99%, less than or equal to 98%, less than or equal to 97%, less than or equal to 96%, less than or equal to 95%, less than or equal to 94%, less than or equal to 93%, less than or equal to 92%, or less than or equal to 91%. Combinations of the above-referenced ranges are also possible (e.g., greater than or equal to 90% and less than or equal to 100%, or greater than or equal to 93% and less than or equal to 100%). Other ranges are also possible.

Build material objects described herein may have a chemical composition similar to the build material powders from which they were formed.

In certain embodiments, the precursor material (e.g., comprising a monomer and/or a polymer comprising an unsaturated carbon-carbon bond) is combined with a build material powder, and a catalyst is present in the binder composition. In some such embodiments, the use of build material powder combined with the precursor material, and a binder composition containing at least a catalyst when used in the printer will cause a metathesis chain-growth polymerization (e.g., ROMP) reaction as the binder composition is selectively deposited onto the build material powder combined with the precursor material. In certain embodiments, the precursor material is coated onto the build material powder. In certain embodiments, the precursor material is liquid, solid, or a mixture of liquid and solid materials during the coating process. In certain embodiments, a coating material is provided comprising the precursor material and at least one of (1) a solvent, (2) a surfactant, (3) an antioxidant, and a (4) solid filler material. In certain embodiments, the solid filler material comprises a compound with a smaller average size than the build material powder. In certain embodiments, the solid filler material comprises a particle, or an aggregate of particles, with a characteristic size of less than 500 nanometers, of between 100 and 1000 nanometers, of between 500 nanometers and 10 micrometers, or of greater than 5 micrometers. In certain embodiments, the solid filler material itself is coated with at least one of an precursor material, molecules of a solvent, a surfactant, and an antioxidant. In certain embodiments, the build material powder is coated with the precursor material and further reacted to graft, adhere, encapsulate, or otherwise adhere the precursor material to the surface of the build material powder where the reaction includes a metathesis chain-growth polymerization (e.g., ROMP) reaction.

In certain embodiments, it is desirable to selectively deposit binder comprising a precursor material (e.g., comprising a monomer and/or polymer comprising an unsaturated carbon-carbon bond) onto a layer or bed of build material powder in which a catalyst is present. Jetting of a precursor material (e.g., as part of a binder composition) onto a layer of build material powder containing a catalyst may catalyze a metathesis chain-growth polymerization (e.g., ROMP) reaction and, according to certain embodiments, build strength within the powder bed such that the region upon which the binder has been selectively deposited will form an object of strength sufficient to be handled by a user without the need for extreme care or delicacy. In certain embodiments, it is desirable to prepare a binder composition exhibiting a mixture of several materials in addition to at least the monomer and/or the polymer, including materials which may not necessarily participate in a metathesis chain-growth polymerization (e.g., ROMP) reaction. Such materials may include (1) a surfactant, (2) a solvent, (3) a diluent, (4) an antioxidant, (5) an inhibitor, (6) a chain transfer agent, or any other additive required for the binder jetting process or to facilitate a metathesis chain-growth polymerization (e.g., ROMP) reaction. In certain embodiments, the build material powder is provided with a catalyst, as may be done, for example with a coating or mixing process. In certain embodiments, the catalyst is imparted to the build material powder while the build material powder is within the build volume, as may be done with a jetting, spraying, or other dispersion apparatus. In certain embodiments, the catalyst is coated on the build material powder using a vapor phase coating process. In certain embodiments, the catalyst is coated on the build material powder using a liquid carrier which is substantially dried, boiled off, vaporized, or otherwise removed prior to selective deposition of the binder composition on the build material powder.

In certain embodiments, it is desirable to utilize a build material powder in which a first portion of the build material powder has been coated with a catalyst (a coated build material powder), and a second portion of build material powder which has not been coated with a catalyst (an uncoated build material powder). In certain embodiments, the first and second portions of build material powder are mixed prior to use in a binder jet printing process, to form a combined build material powder. Coating a smaller amount of build material powder may be more efficient, and done with greater ease, than coating a larger amount of the same build material powder. In certain embodiments, the coated and uncoated build material powders are mixed in a blending apparatus, such as a rotating drum, a v-blender, a cone blender, and the like. In certain embodiments the coated build material powder is present in an amount of greater than or equal to 1 wt %, greater than or equal to 2 wt %, greater than or equal to 5 wt %, greater than or equal to 10 wt %, greater than or equal to 25 wt %, greater than or equal to 45 wt % or greater of the combined build material powder. In some embodiments, the coated build material powder is present in an amount of less than or equal to 60 wt %, less than or equal to 50 wt %, less than or equal to 40 wt %, less than or equal to 25 wt %, less than or equal to 10 wt %, or less of the combined build material powder. For example, the coated build material powder may be present in an amount of in any proportion between 1% and 10% of the combined build material powder, in any proportion between 5% and 50% of the combined build material powder, in any proportion between 45% and 60% of the combined build material powder.

In certain embodiments, a filler material comprising a material different than the build material, is coated with a catalyst and mixed with the build material powder. Coating of a filler material different than a build material may impart several advantages, including at least: (1) no requirement for a supply chain or procedure for preparing the build material powder with a direct coating of a catalyst, (2) the ability to utilize the same catalyst-containing (or catalyst-coating) filler material with many different build material powders and/or build materials, (3) the ease of mixing two finely-divided materials as compared to mixing a liquid with a finely divided material that may also require drying or removal of at least a component of the liquid. In certain embodiments, the filler material comprises silica, iron oxide, or any other metal oxide. In certain embodiments, the size of filler material is smaller than the size of the build material powder. In certain embodiments, the filler material is present at an amount of less than 0.5 wt % of the build material powder. In certain embodiments, the filler material may be present at an amount of between 0.1 and 1 wt % of the build material powder. In certain embodiments, the filler material may be present at an amount of between 0.5 and 5 wt % of the build material powder.

In certain embodiments, it is desirable to include various non-participating chemical components (including monomeric or polymeric components) in a binder composition or build material powder coating that do not participate in a metathesis chain-growth polymerization (e.g., ROMP) reaction. Various desirable attributes may include: (1) the ability to tune the viscosity and/or surface tension of a binder comprising the non-participating chemical components, (2) the ability to tune the properties of a polymerized material such as attributes for debinding (such as the total amount of solids formed, an amount of liquid present, an amount of porosity, and the like), (3) the ability to tune the flow and wetting properties of the binder, including the temperature at which a binder may be a liquid or a solid. Such components may include, but are not limited to, solvents, surfactants, diluents, and the like.

In certain embodiments, the catalyst is a latent catalyst. In some such embodiments, the latent catalyst is included in coating materials such as the precursor material, that may be associated with the build material powder. The inventors have recognized and appreciated that adding both catalysts and the precursor material as a coating to the build material powder may produce the premature, and undesired, execution of a metathesis chain-growth polymerization (e.g., ROMP) reaction before the selective deposition of binder composition has been performed, but that the use of a latent catalyst may frustrate the polymerization reaction until an activator or other suitable trigger has been applied to the mixture comprising the latent catalyst, build material powder, and precursor material comprising the monomers and/or polymers.

Latent catalysts can be utilized to promote control of the reactivity of a given system. Latent Catalysts can be incorporated into a system with reactive species (e.g., monomers and polymers) without reacting until a given stimulus is applied. There may still be a time dependency for latent systems which precludes indefinite latency, however, but reasonable latency will allow sufficient pot-life (the time between the materials are mixed and when the reaction begins) to promote control of their reactivity. Examples of latent catalysts (e.g., latent catalysts for olefin metathesis polymerization reactions include, but are not limited to: latent catalysts triggered by mechanical activation (Organometallics 2012, 31, 6, 2476-2481), latent catalysts triggered by acid activation (Euro. Poly. J. 62, 2015, 116-123), latent catalysts triggered by thermal activation (Organometallics. 2011 Dec. 26; 30(24): 6713-6717.) and latent catalysts triggered by electromagnetic activation (Synthesis 2018, 50, 49-63. 10.1055/s-0036-1589113).

In some embodiments, the activator coats the build material powder. In some embodiments, the activator is part of the binder composition. Activators for latent catalysts can be mixed within a reactive system (such as a one-part system) or added to the system as a second step (such as a 2-part system). Latent catalysts that are triggered by light, by heat or by mechanical activation are usually utilized as a one-part system (where the latent catalyst is mixed with the reactive molecules). Chemical activation (the addition of an activator such as acid, for example) may be achieved in a 2-part system where the activator is added to the system. There may be times when a one-part system can be separated into two parts and applied separately. According to one embodiment, binder jetting is achieved through the use of a two-part system where the catalyst and the activator are separated, one being applied to the build material powder and the other being applied to the binder composition. Upon deposition, the latent catalyst is mixed with the activator, releasing the active catalyst which proceeds to activate (e.g., initiate and propagate) the chemical reaction catalyzed by the catalyst. Examples of acidic chemical activators include, but are not limited to: organic acids (toluene sulfonic acid, 4-(trifluoromethyl)benzenesulfonic acid, triflic acid, acetic acid, etc.), mineral acids (sulfuric acid, nitric acid, hydrochloric acid, etc.) and polymeric acids (poly acrylic acid, Poly(4-styrenesulfonic acid), etc. and copolymers thereof).

### Example

As a test of the above-described approach to fabrication, commercial samples of a dicyclopentadiene blended monomer mixture (NexTene™ PCX 01) were obtained along with B component from NexTene™ as a catalyst. The catalyst may be mixed with powder particles of a primary material in any suitable manned prior to jetting the dicyclopentadiene onto the powder-catalyst mixture.

As one example of how powder particles of a primary material (in this case aluminum) may be mixed with the catalyst, the following procedure was followed. 13.84 mg of the catalyst were added to 30 mL of hexanes and stirred until the catalyst was mainly dissolved. Once completed, the mixture was added to a mixing cup containing 100 grams of aluminum powder and mixed together, resulting in a uniform slurry. This slurry was then poured into an oven safe dish and heated to remove the hexanes. The resulting dry powder was deemed to have a well mixed amount of catalyst. To fabricate solid material, the dicyclopentadiene may be deposited onto a bed of this powder.

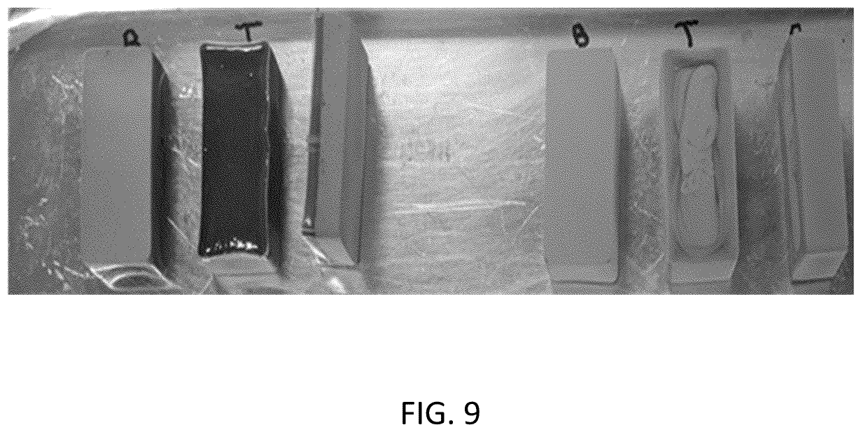

In FIG. 9, representative parts are shown that were created by mixing the primary powder, catalyst and cyclic olefin(s) in a non-stick mold and mildly heating it to drive off any leftover solvent used in solvating the catalyst. While 17-4 stainless steel and aluminum bars are shown in the figure, bars of wood resin, blended carbon powder, and ceramic microspheres were also created.

To probe mechanical properties, a TRS analysis was performed, showing that these bars had a high bending strength (See Table 1).

TABLE 1
TRS strength data of the created bars

| Sample Material | TRS (MPa) |
|---|---|
| 17-4 Stainless (Carpenter) | 32.98 |
| Aluminum Powder | 23.94 |

On qualitative handling, no visible cracks were observed in the bars after heating. From a debinding perspective, the polymerized resin was subjected to TGA analysis, which showed almost all of the material is burned away at around 500° C. in all three of the sintering gases of interest (Table 2).

TABLE 2
TGA burn-off percentages of the polymerized
pure resin material in various gases

| Gas | % remaining after heating to 800° C. |
|---|---|
| Air | 1.6 |
| Argon | 0.2 |
| Forming Gas | 0.8 |

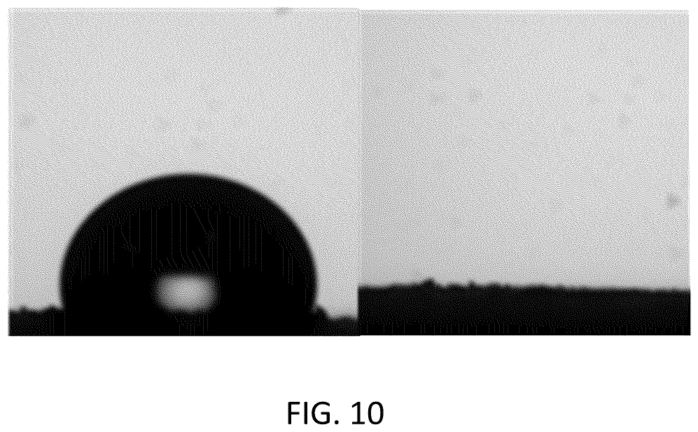

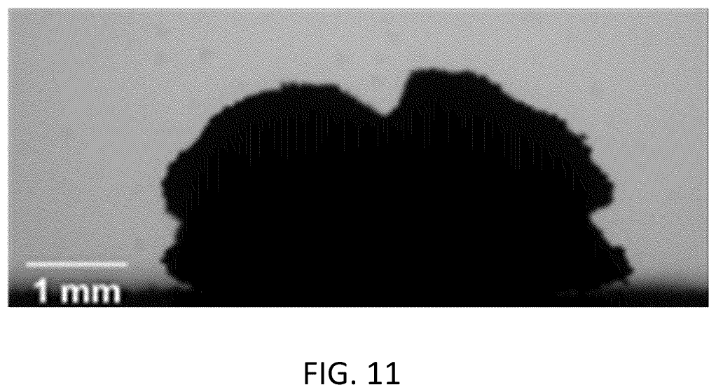

As a proof of concept, a droplet of the dicyclopentadiene blended monomer mixture was placed onto a packed bed of aluminum powder pre-mixed with the catalyst. As shown in FIG. 10, the droplet somewhat wetted the powder bed on impact and was incorporated inward after approximately one second. Curing the powder bed at 100° C. for 8 hrs produced a solid powder pebble (FIG. 11), showing not only that a part can be generated by monomer printing but also that the monomer can significantly penetrate before significantly polymerizing.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of additive manufacturing comprising:
forming one or more parts by performing, a plurality of times:
depositing a layer of build material powder, wherein particles of the build material powder are coated with a catalyst; and
depositing a binder composition on at least a portion of the layer of build material powder, the binder composition comprising a precursor material comprising a monomer and/or a polymer, the monomer and/or polymer comprising an unsaturated carbon-carbon bond, thereby causing the monomer and/or polymer of the precursor material to undergo a metathesis chain-growth polymerization reaction catalyzed by the catalyst.

2. The method of claim 1, wherein the precursor material comprises a monomer comprising an unsaturated carbon-carbon bond.

3. The method of claim 2, wherein the monomer comprises dicyclopentadiene.

4. The method of claim 1, wherein the monomer and/or polymer comprises two or more unsaturated carbon-carbon bonds.

5. The method of claim 1, wherein the monomer and/or polymer comprises a bicyclic ring.

6. The method of claim 1, wherein the metathesis chain-growth polymerization reaction comprises a ring-opening olefin metathesis polymerization reaction.

7. The method of claim 6, wherein the catalyst comprises a metal center.

8. The method of claim 7, wherein the metal center is a transition metal.

9. The method of claim 7, wherein the catalyst comprises a Grubbs catalyst.

10. The method of claim 1, wherein the monomer and/or polymer are a first monomer and/or first polymer, and wherein the precursor material further comprises a second monomer and/or a second polymer comprising an unsaturated carbon-carbon bond, wherein the first monomer and/or first polymer is different than the second monomer and/or second polymer.

11. The method of claim 10, wherein the first monomer and/or first polymer comprises dicyclopentadiene and the second monomer and/or the second polymer comprises cyclooctene.

12. The method of claim 1, further comprising curing the deposited build material powder and the deposited binder composition, wherein the curing causes or accelerates the polymerization reaction.

13. The method of claim 12, wherein the curing comprises heating the deposited build material powder and the deposited binder composition.

14. The method of claim 1, wherein the precursor material comprises the monomer and/or the polymer in an amount greater than or equal to 80 wt %.

15. The method of claim 1, wherein the catalyst that coats the build material powder is part of a coating on the build material powder, and the catalyst is present in the coating on the build material powder in an amount of greater than or equal to 0.1 wt % by weight of the coating.

16. The method of claim 1, wherein the binder composition further comprises a solvent and/or a surfactant.

17. The method of claim 1, wherein the build material powder comprises a metal powder.

18. A method of additive manufacturing comprising:
forming one or more parts by performing, a plurality of times:
depositing a layer of build material powder, wherein particles of the build material powder are coated with a precursor material comprising a monomer and/or a polymer, the monomer and/or polymer comprising an unsaturated carbon-carbon bond; and
depositing a binder composition on at least a portion of the layer of build material powder, the binder composition comprising a catalyst, thereby causing the monomer and/or polymer of the precursor material to undergo a metathesis chain-growth polymerization reaction catalyzed by the catalyst.

19. A method of additive manufacturing comprising:
forming one or more parts by performing, a plurality of times:
depositing a layer of build material powder, wherein particles of the build material powder are coated with a latent catalyst and a precursor material comprising a monomer and/or a polymer, the monomer and/or polymer comprising an unsaturated carbon-carbon bond; and
depositing a binder composition on at least a portion of the layer of build material powder, the binder composition comprising an activator, thereby causing the monomer and/or polymer of the precursor material to undergo a metathesis chain-growth polymerization reaction catalyzed by the catalyst upon activation by the activator.

20. A method of additive manufacturing comprising:
forming one or more parts by performing, a plurality of times:
depositing a layer of build material powder, wherein particles of the build material powder are coated with an activator; and
depositing a binder composition on at least a portion of the layer of build material powder, the binder composition comprising a latent catalyst and a precursor material comprising a monomer and/or a polymer, the monomer and/or polymer comprising an unsaturated carbon-carbon bond, thereby causing the monomer and/or polymer of the precursor material to undergo a metathesis chain-growth polymerization reaction catalyzed by the catalyst upon activation by the activator.
